(19) United States
(12) Patent Application Publication
(10) Pub. No.: US 2013/0024608 A1
(43) Pub. Date: Jan. 24, 2013

(54) FLASH MEMORY APPARATUS

(71) Applicants: DU-WON HONG, Suwon-si (KR); HAN-CHAN JO, Yeongin-si (KR)

(72) Inventors: DU-WON HONG, Suwon-si (KR); HAN-CHAN JO, Yeongin-si (KR)

(73) Assignee: SAMSUNG ELECTRONICS CO., LTD., SUWON-SI (KR)

(21) Appl. No.: 13/551,640

(22) Filed: Jul. 18, 2012

(30) Foreign Application Priority Data
Jul. 18, 2011 (KR) 10-2011-0071088

(51) Int. Cl. G06F 12/00

(52) U.S. Cl. 711/103; 711/E12.008

(57) ABSTRACT

A flash memory apparatus includes a flash memory and a control unit for controlling the flash memory. The flash memory includes multiple blocks, each block of the multiple blocks corresponding to multiple word lines, and each word line of the multiple word lines corresponding to a first bit page and at least one second bit page. The control unit is configured to map a logic address included in a host's write request received from a host to a first process page of multiple in a first process block of the multiple blocks, and to program the first process page. The first process page is only the first bit page.

### CROSS-REFERENCE TO RELATED APPLICATIONS

A claim of priority under 35 U.S.C. §119 is made to Korean Patent Application No. 10-2011-0071088, filed on Jul. 18, 2011, in the Korean Intellectual Property Office, the entire contents of which are hereby incorporated by reference.

### BACKGROUND

Flash memory apparatuses include flash memory in which data may be written and from which data may be read. However, even after data is normally written in the flash memory, the data may be damaged due to characteristics of the flash memory. Thus, since erroneous data is read when the data is damaged, the reliability of the flash memory apparatus may not be ensured.

Accordingly, a flash memory apparatus capable of preventing damage of data and having strong reliability is required. The inventive concept relates to a reliable flash memory apparatus.

### SUMMARY

According to an aspect of the inventive concept, a flash memory apparatus includes a flash memory and a control unit for controlling the flash memory. The flash memory includes multiple blocks, each block of the multiple blocks corresponding to multiple word lines, and each word line of the multiple word lines corresponding to a first bit page and at least one second bit page. The control unit is configured to map a logic address included in a host's write request received from a host to a first process page of multiple in a first process block of the multiple blocks, and to program the first process page. The first process page is only the first bit page.

The control unit may include a volatile memory for loading metadata, and a memory controller for mapping the logic address to the first process page based on the metadata. The memory controller manages the metadata so as to prevent the first process page mapped to the logic address to become the at least one second bit page.

The host's write request may further include program data, where the program data is stored in the volatile memory. The memory controller may program the program data in the first process page.

The first bit page may be a least significant bit (LSB) page. One bit page from among the at least one second bit page may be a most significant bit (MSB) page.

The control unit may be further configured to copy n valid pages (where n is an integer greater than 1) in a second process block, which is one of the multiple, to ith through (i+n−1)th pages (where i is an integer equal to or greater than 0) that are n continuous second process pages in a third process block, which is one of the multiple blocks.

The control unit may be further configured to set (i+n)th through kth pages (where k is an integer greater than i+n−1) as interference barrier pages. An mth word line (where m is an integer equal to or greater than 0) from among multiple word lines corresponding to the n continuous second process pages may have a highest word line number. Also, the kth page may be an MSB page corresponding to an (m+1)th word line.

The control unit may not program the interference barrier pages. Alternatively, the control unit may be further configured to program dummy data in LSB pages from among the interference barrier pages. The control unit may be further configured to erase the second process block after the interference barrier pages are set.

The control unit may be further configured to copy multiple valid pages of a fourth process block that is one of the multiple blocks to the third process block. The multiple valid pages of the fourth process block may be programmed in pages from a (k+1)th page of the third process block.

According to another aspect of the inventive concept, an electronic apparatus includes a flash memory and a control unit for controlling the flash memory. The flash memory includes multiple memory cells that are N-bit multi-level cells (MLCs) (where N is an integer greater than 1). The control unit is configured to program M first process pages (where M is an integer greater than 0) in the flash memory in response to M host's write requests. Each of the first memory cells corresponding to the M first process pages from among the memory cells represents 1-bit information, where M×(N−1) pages that share the first memory cells with the M first process pages are not programmed.

The flash memory may include a first source block and a target block, where the control unit is further configured to copy multiple valid pages in the first source block to multiple continuous second process pages in the target block. Each of multiple second memory cells corresponding to the second process pages from among the multiple memory cells represents p-bit information (where p=1, 2, . . . , N).

After the second memory cells are programmed, the control unit may be further configured to set multiple pages adjacent to the multiple second process pages in the target block as interference barrier pages.

The control unit does not program the interference barrier pages. Alternatively, the control unit programs dummy data in LSB pages from among the interference barrier pages.

The flash memory may be included in a solid state drive (SSD).

According to another aspect of the inventive concept, a method is provided for controlling a flash memory by a control unit. The method includes programming a first process page to store program data from multiple host's write requests in a source block, the source block including valid and invalid pages; copying the valid pages in the source block to corresponding continuous pages in a target block, the continuous pages including at least one least significant bit (LSB) page and at least one most significant bit (MSB) page; and setting at least one interference barrier page in the target block following the continuous pages.

### BRIEF DESCRIPTION OF THE DRAWINGS

Illustrative embodiments will be more clearly understood from the following detailed description taken in conjunction with the accompanying drawings, in which:

FIG. 1 is a block diagram of a flash memory apparatus, according to an embodiment of the inventive concept;

FIG. 2 is a diagram showing a program operation performed in the flash memory apparatus illustrated in FIG. 1 in response to a host's write request, according to an embodiment of the inventive concept;

FIG. 3 is a flowchart of an example of a method for performing a programming operation in the flash memory apparatus illustrated in FIG. 2, according to an embodiment of the inventive concept;

FIG. 4 is a diagram showing a memory cell array of a flash memory illustrated in FIG. 1, according to an embodiment of the inventive concept;

FIG. 5 is a diagram showing an example of one the blocks illustrated in FIG. 4, according to an embodiment of the inventive concept;

FIG. 6 is a diagram showing an example of a least significant bit (LSB) page and a most significant bit (MSB) page corresponding to each word line in the block illustrated in FIG. 5, according to an embodiment of the inventive concept;

FIGS. 7A through 7C are graphs showing dispersions of memory cells of the flash memory illustrated in FIG. 1, according to embodiments of the inventive concept;

FIGS. 8A and 8B are graphs respectively showing a dispersion of memory cells to which an LSB page is programmed and a dispersion of memory cells to which an MSB page is programmed, in 2-bit multi-level cells (MLCs), according to an embodiment of the inventive concept;

FIG. 9 illustrates tables for describing an example of a method of performing a programming operation in the flash memory apparatus illustrated in FIG. 2 in response to multiple host's write requests, according to an embodiment of the inventive concept;

FIG. 10 is a diagram showing a first process block including pages programmed according to the tables illustrated in FIG. 9, according to an embodiment of the inventive concept;

FIG. 11 is a diagram showing a garbage collection operation performed in the flash memory apparatus illustrated in FIG. 1, according to an embodiment of the inventive concept;

FIG. 12 is a flowchart of an example of a method for performing a garbage collection operation in the flash memory apparatus illustrated in FIG. 11, according to an embodiment of the inventive concept;

FIG. 13 is a diagram showing an example of blocks on which a garbage collection operation is performed in the flash memory apparatus illustrated in FIG. 11, according to an embodiment of the inventive concept;

FIG. 14 is a table showing correspondence between valid pages of the source block illustrated in FIG. 13 and pages of a target block illustrated in FIG. 13, according to an embodiment of the inventive concept;

FIGS. 15 through 17 are tables showing a process of programming the target block illustrated in FIG. 13 in accordance with the table illustrated in FIG. 14, according to an embodiment of the inventive concept;

FIG. 18 is a graph showing an example of a dispersion of memory cells corresponding to LSB pages from among interference barrier pages illustrated in FIG. 17 after a garbage collection operation is performed, according to an embodiment of the inventive concept;

FIG. 19 is a diagram showing another example of blocks on which a garbage collection operation is performed in the flash memory apparatus illustrated in FIG. 11, according to an embodiment of the inventive concept;

FIG. 20 is a table showing an example of a target block illustrated in FIG. 19, according to an embodiment of the inventive concept;

FIG. 21 is a graph showing an example of a dispersion of memory cells corresponding to LSB pages from among interference barrier pages illustrated in FIG. 19 after a garbage collection operation is performed, according to an embodiment of the inventive concept;

FIG. 22 is a diagram showing a garbage collection operation performed in the flash memory apparatus illustrated in FIG. 1, according to another embodiment of the inventive concept;

FIG. 23 is a flowchart of an example of a method for performing a garbage collection operation in the flash memory apparatus illustrated in FIG. 22, according to an embodiment of the inventive concept;

FIG. 24 is a diagram showing an example of blocks on which a garbage collection operation is performed in the flash memory apparatus illustrated in FIG. 22, according to an embodiment of the inventive concept;

FIG. 25 is a diagram showing an example of LSB and MSB pages corresponding to multiple word lines in a target block illustrated in FIG. 24, according to an embodiment of the inventive concept;

FIG. 26 is a diagram showing an operation performed in the flash memory apparatus illustrated in FIG. 1, according to another embodiment of the inventive concept;

FIG. 27 is a flowchart of an example of a method for performing an operation in the flash memory apparatus illustrated in FIG. 26, according to an embodiment of the inventive concept;

FIG. 28 is a diagram showing an example of blocks on which an operation is performed in the flash memory apparatus illustrated in FIG. 26, according to an embodiment of the inventive concept;

FIG. 29 is a diagram showing an example of LSB and MSB pages corresponding to multiple word lines in a target block illustrated in FIG. 28, according to an embodiment of the inventive concept;

FIG. 30 is a diagram showing an example of a first process block including pages programmed in response to multiple host's write requests in the flash memory apparatus illustrated in FIG. 2, and LSB, CSB, and MSB pages corresponding to multiple word lines in the first process block, according to an embodiment of the inventive concept;

FIG. 31 is a diagram showing another example of blocks on which a garbage collection operation is performed in the flash memory apparatus illustrated in FIG. 11, according to an embodiment of the inventive concept;

FIG. 32 is a diagram showing an example of LSB, CSB, and MSB pages corresponding to multiple word lines in a target block illustrated in FIG. 31, according to an embodiment of the inventive concept;

FIG. 33 is a diagram showing another example of blocks on which a garbage collection operation is performed in the flash memory apparatus illustrated in FIG. 11, according to an embodiment of the inventive concept;

FIG. 34 is a block diagram of a computing system including a flash memory apparatus, according to an embodiment of the inventive concept;

FIG. 35 is a block diagram of a memory card according to an embodiment of the inventive concept;

FIG. 36 is a block diagram of a solid state drive (SSD), according to an embodiment of the inventive concept; and

FIG. 37 is a block diagram of a network system including a server system including an SSD, according to an embodiment of the inventive concept.

### DETAILED DESCRIPTION OF THE EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated.

The terminology used herein is for the purpose of describing particular embodiments and is not intended to limit the inventive concept. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” refers to one of or a combination of at least two listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept.

Embodiments of the inventive concept are described herein with reference to schematic illustrations of idealized embodiments (and intermediate structures) of the inventive concept. As such, variations from the shapes of the illustrations as a result, for example, of manufacturing techniques and/or tolerances, are to be expected. Thus, the embodiments of the inventive concept should not be construed as limited to the particular shapes of regions illustrated herein, but are to include deviations in shapes that result, for example, from manufacturing.

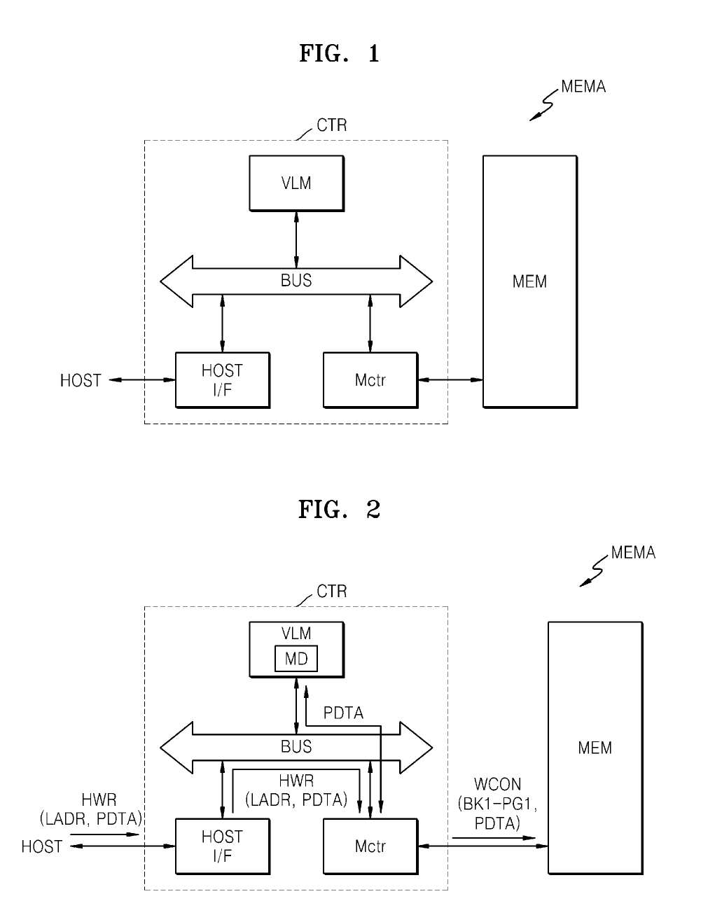

FIG. 1 is a block diagram of a flash memory apparatus, according to an embodiment of the inventive concept.

Referring to FIG. 1, flash memory apparatus MEMA includes a flash memory MEM and a control unit CTR. The flash memory MEM may be a NAND flash memory, for example.

The control unit CTR controls the flash memory MEM. That is, the control unit CTR controls or manages overall operations performed in the flash memory MEM. The control unit CTR includes a host interface HOST UF, a memory controller Mctr, and a volatile memory VLM, which are connected to one other via a bus BUS.

The host interface HOST I/F may receive and transmit a request from a host to the memory controller Mctr. The host's request may be a write request or a read request, for example.

The memory controller Mctr accesses the flash memory MEM, and controls the flash memory MEM to perform programming, erase, or read operations. The programming, erase, or read operations may be performed in response to the host's request, or according to a garbage collection operation, discussed below. The garbage collection operation may be performed due to lack of free blocks.

The volatile memory VLM may temporarily store program data to be written in or read from the flash memory MEM. Also, the volatile memory VLM may load information required to operate the memory controller Mctr, for example, metadata. The metadata refers to information required to manage the flash memory MEM.

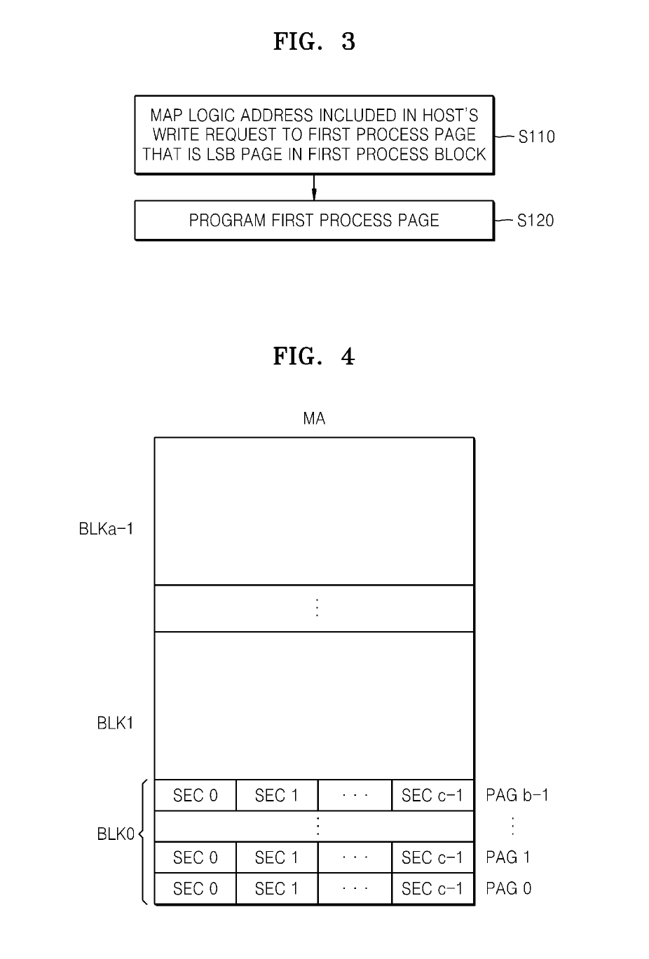

A case in which the host's request is a write request will now be described with reference to FIGS. 2 and 3.

FIG. 2 is a diagram showing a programming operation performed in the flash memory apparatus MEMA illustrated in FIG. 1, in response to a host's write request HWR, according to an embodiment of the inventive concept. FIG. 3 is a flowchart showing an example of a process for performing a programming operation in the flash memory apparatus MEMA illustrated in FIG. 2, according to an embodiment of the inventive concept.

Referring to FIGS. 2 and 3, the memory controller Mctr of the control unit CTR maps a logic address LADR included in the host's write request HWR to a first process page PG1, which is a least significant bit (LSB) page (hereinafter, also referred to as a first bit page), in a first process block BK1 (S110). The memory controller Mctr programs the first process page PG1 (S120). As such, program data PDTA included in the host's write request HWR is stored in the first process page PG1 of the flash memory MEM.

FIG. 4 is a diagram showing a memory cell array MA of the flash memory MEM illustrated in FIG. 1, according to an embodiment of the inventive concept.

Referring to FIGS. 1 and 4, the flash memory MEM of the flash memory apparatus MEMA may include the memory cell array MA. The memory cell array MA may include a blocks (where a is an integer greater than 1), indicated as the zeroth block BLK0 through the (a-1)th block BLKa-1. Each of the zeroth through (a-1)th block BLK0 through BLKa-1 includes b pages (where b is an integer greater than 1), indicated as the zeroth page PAG0 through the (b-1)th page PAGb-1. Each of the zeroth through (b-1)th pages PAG0 through PAGb-1 includes c sectors (where c is an integer greater than 1), indicated as the zeroth sector SEC0 through the (c-1)th sector SECc-1. Although the zeroth through (b-1)th pages PAG0 through PAGb-1 and the zeroth through (c-1)th sectors SEC0 through SECc-1 are illustrated only in the zeroth block BLK0 in FIG. 4 for brevity, it is understood that the first through (a-1)th blocks BLK1 through BLKa-1 have the same structure as the zeroth block BLK0.

The flash memory MEM illustrated in FIG. 1 may include multiple memory cell arrays having the same structure, and performing the same operation as the memory cell array MA illustrated in FIG. 4. The memory cell array MA includes multiple memory cells. Each memory cell may be a single-level cell (SLC) or a multi-level cell (MLC).

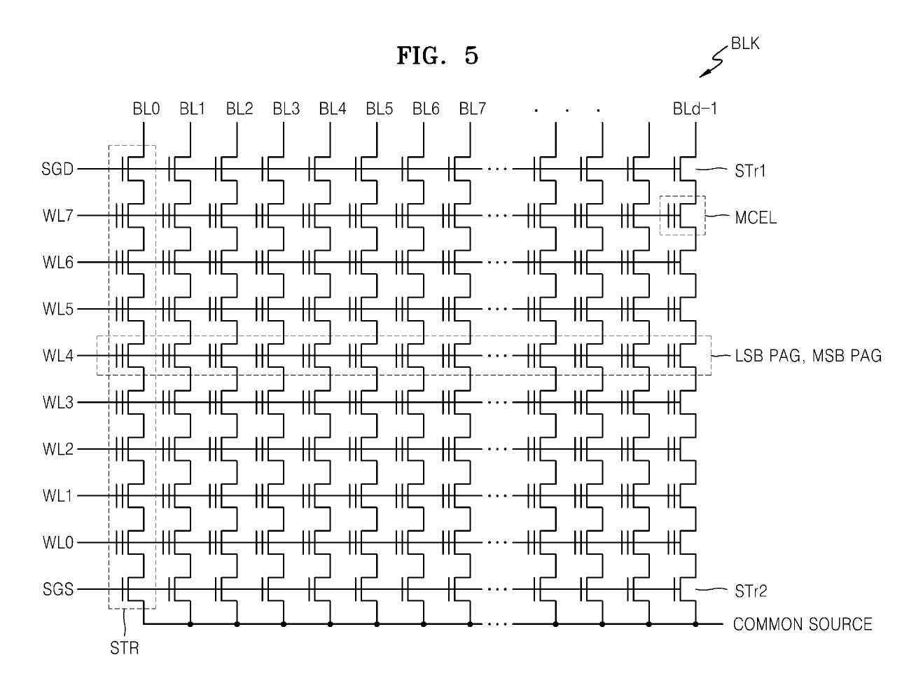

FIG. 5 is a diagram showing an example of one of the zeroth through (a-1)th blocks BLK0 through BLKa-1 illustrated in FIG. 4, according to an embodiment of the inventive concept. In FIG. 5, it is assumed that memory cells of the memory cell array MA illustrated in FIG. 4 are 2-bit MLCs, for convenience of explanation.

Referring to FIG. 5, block BLK corresponds to zeroth through seventh word lines WL0 through WL7 and zeroth through (d-1)th bit lines BL0 through BLd-1 (where d is an integer greater than 1). The block BLK includes d strings STR, each including eight memory cells MCEL connected in series, along a direction of the zeroth through (d-1)th bit lines BL0 through BLd-1. Each string STR also includes a drain selection transistor Str1 and a source selection transistor Str2 connected at two ends of the memory cells MCEL connected in series.

When the memory cells MCEL are 2-bit MLCs, each of the zeroth through seventh word lines WL0 through WL7 corresponds to an LSB page LSB PAG and a most significant bit (MSB) page MSB PAG. That is, when the memory cells MCEL are 2-bit MLCs, one word line in the block BLK corresponds to two pages (LSB PAG and MSB PAG). The LSB page LSB PAG may also be referred to as a first bit page, and the MSB page MSB PAG may also be referred to as a second bit page. A pair including an LSB page LSB PAG and an MSB page MSB PAG share d memory cells MCEL.

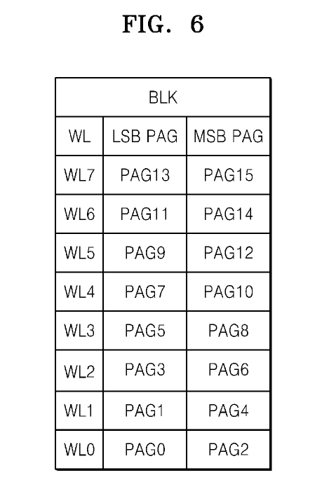

FIG. 6 is a diagram showing an example of an LSB page LSB PAG and an MSB page MSB PAG corresponding to each of the zeroth through seventh word lines WL0 through WL7 in the block BLK illustrated in FIG. 5, according to an embodiment of the inventive concept.

Referring to FIGS. 5 and 6, each of the zeroth through seventh word lines WL0 through WL7 in the block BLK corresponds to a pair of an LSB page LSB PAG and an MSB page MSB PAG. A page number of the LSB page LSB PAG corresponding to each of the zeroth through seventh word lines WL0 through WL7 is less than the page number of the MSB page MSB PAG. For example, the zeroth word line WL0 corresponds to a pair including the zeroth page PAG0 having a page number of 0 as the LSB page LSB PAG and a second page PAG2 having a page number of 2 as the MSB page MSB PAG. However, the case illustrated in FIG. 6 is merely an example, and page numbers of the LSB page LSB PAG and the MSB page MSB PAG corresponding to each of the zeroth through seventh word lines WL0 through WL7 may vary without departing from the scope of the present teachings.

When the flash memory MEM of the flash memory apparatus MEMA illustrated in FIG. 1 is a NAND flash memory, the flash memory apparatus MEMA may be configured to have the structure illustrated in FIG. 5.

In the flash memory apparatus MEMA having the structure illustrated in FIG. 5, an erase operation is performed in units of a block BLK and a programming operation is performed in units of a page PAG. FIGS. 5 and 6 show an example in which one block BLK includes sixteen pages PAG corresponding to the zeroth through seventh word lines WL0 through WL7, respectively. However, according to various embodiments of the inventive concept, the block BLK of the memory cell array MA may include more or fewer memory cells and pages than the memory cells MCEL and the pages PAG illustrated in FIGS. 5 and 6.

Also, although 2-bit MLCs are assumed to be illustrated in FIGS. 5 and 6, the memory cells MCEL may be SLCs or 3-or-more-bit MLCs. When the memory cells MCEL are SLCs, each of the zeroth through seventh word lines WL0 through WL7 in the block BLK corresponds to one page. When the memory cells MCEL are 3-bit MLCs, each of the zeroth through seventh word lines WL0 through WL7 corresponds to an LSB page, a center significant bit (CSB) page, and an MSB page. Thus, other than the number of pages corresponding to each of the zeroth through seventh word lines WL0 through WL7 varying according to the type of the memory cells MCEL, the structure illustrated in FIG. 5 may also be applied to SLCs or 3-or-more-bit MLCs.

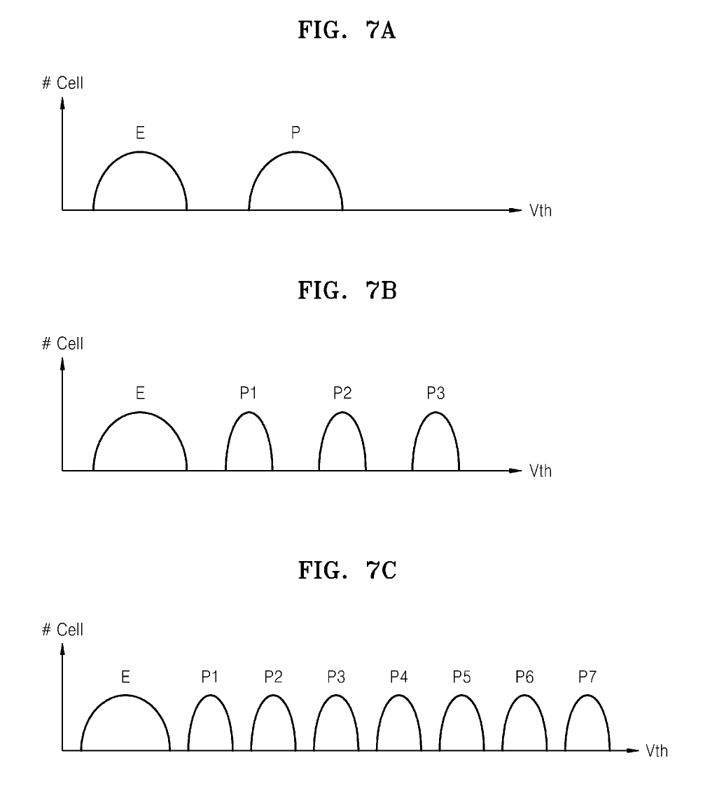

FIGS. 7A through 7C are graphs showing dispersions of memory cells MCEL of the flash memory MEM illustrated in FIG. 1. When the flash memory MEM illustrated in FIG. 1 includes the memory cells MCEL having the structure illustrated in FIG. 5, the memory cells MCEL illustrated in FIG. 5 may have a threshold voltage Vth included in one of the dispersions illustrated in FIGS. 7A through 7C, according to the number of bits of programmed program data.

FIG. 7A shows a cell dispersion where the memory cells MCEL are SLCs programmed in units of one bit. FIG. 7B shows a cell dispersion where the memory cells MCEL are 2-bit MLCs programmed in units of two bits. FIG. 7C shows a cell dispersion where the memory cells MCEL are 3-bit MLCs programmed in units of three bits. Each of the memory cells MCEL has a threshold voltage Vth included in one of an erase state E and a programming state P when the memory cells MCEL are SLCs, according to the value of programmed data. Each of the memory cells MCEL has a threshold voltage Vth included in one of the erase state E and first through third program states P1 through P3 when the memory cells MCEL are 2-bit MLCs, according to the value of programmed data. Each of the memory cells MCEL has a threshold voltage Vth included in one of the erase state E and first through seventh programming states P1 through P7 when the memory cells MCEL are 3-bit MLCs, according to the value of programmed data.

However, the configuration of the memory cells MCEL are not limited as shown in FIGS. 7A through 7C, and may be programmed in units of four or more bits. Also, the flash memory MEM illustrated in FIG. 1 may include memory cells MCEL programmed in units of different numbers of bits from one another. A flash memory of a flash memory apparatus according to an embodiment of the inventive concept includes MLCs. However, the flash memory may include both SLCs and MLCs. Also, the flash memory may include different-bit MLCs.

For convenience of explanation, the following description assumes that the flash memory of a flash memory apparatus, according to an embodiment of the inventive concept, includes 2-bit MLCs. However, the flash memory apparatus may be implement using 3-or-more-bit MLCs, in various embodiments, without departing from the scope of the present teachings.

Referring again to FIG. 5, initially, an LSB page LSB PAG is programmed to represent 1-bit information in one memory cell MCEL. Then, an MSB page MSB PAG may be programmed to represent 2-bit information in the memory cell MCEL. Accordingly, two bits may be allocated to the memory cell MCEL that is a 2-bit MLC.

N bits may be allocated to one memory cell MCEL that is an N-bit MLC (where N is an integer greater than 2). The memory cell MCEL may be programmed in the order of an LSB page, at least one (N−2) CSB page, and an MSB page to represent N-bit information in the memory cell MCEL. Hereinafter, the LSB page may also be referred to as a first bit page, and the at least one (N−2) CSB page and the MSB page may be referred to as second bit pages.

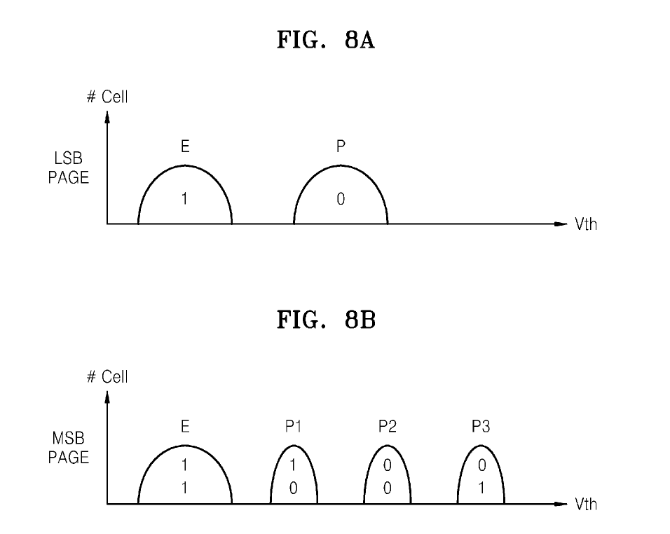

FIGS. 8A and 8B are graphs respectively showing a dispersion of memory cells to which an LSB page is programmed and a dispersion of memory cells to which an MSB page is programmed, in 2-bit MLCs, according to an embodiment of the inventive concept.

Referring to FIGS. 8A and 8B, the memory cells to which an LSB page is programmed are programmed in one of an erase state E and a programming state P. A memory cell in the erase state E and a memory cell in the programming state P may respectively represent 1-bit information “1” and “0”. When an LSB page is programmed and then an MSB page is programmed, the memory cells to which an MSB page is programmed are programmed in one of the erase state E, a first program state P1, a second program state P2, and a third program state P3. A memory cell in the erase state E, a memory cell in the first program state P1, a memory cell in the second program state P2, and a memory cell in the third program state P3 may respectively represent 2-bit information “11”, “10”, “00”, and “01”. For example, when a memory cell stores “10”, “1” is information regarding the LSB page and “0” is information regarding the MSB page. When an LSB page is programmed and then an MSB page is not programmed, a dispersion of memory cells to which only an LSB page is programmed is the same as the cell dispersion of SLCs illustrated in FIG. 7A.

A method of performing a programming operation in response to a host's write request will now be described in detail with reference to FIGS. 2 and 3, according to an embodiment of the inventive concept.

Referring again to FIGS. 2 and 3, the host interface HOST I/F receives the host's write request HWR from a host and transmits the host's write request HWR to the memory controller Mctr. The host's write request HWR includes the logic address LADR and the program data PDTA.

The memory controller Mctr may temporarily store the program data PDTA in the volatile memory VLM. Also, metadata MD may be loaded to the volatile memory VLM.

The memory controller Mctr maps the logic address LADR included in the host's write request HWR to the first process page PG1, which is an LSB page, in the first process block BK1 (S110). That is, the memory controller Mctr may convert the logic address LADR into a physical address BK1-PG1 indicating the first process page PG1 in the first process block BK1. The first process block BK1 is one of multiple blocks (the zeroth through (a-1)th blocks BLK0 through BLKa-1 illustrated in FIG. 4) included in the flash memory MEM. The first process block BK1 may have the structure of the block BLK illustrated in FIG. 5. The first process page PG1 is one of multiple pages (the zeroth through (b-1)th pages PAG0 through PAGb-1 illustrated in FIG. 4) included in the first process block BK1.

Also, the first process page PG1 is an LSB page. When the first process block BK1 has the structure illustrated in FIGS. 5 and 6, the first process block BK1 includes zeroth through fifteenth pages PAG0 through PAG15. LSB pages from among the zeroth through fifteenth pages PAG0 through PAG15 are the zeroth, first, third, fifth, seventh, ninth, eleventh, and thirteenth pages PAG0, PAG1, PAG3, PAG5, PAG7, PAG9, PAG11, and PAG13. Accordingly, as an LSB page, the first process page PG1 may be one of the zeroth, first, third, fifth, seventh, ninth, eleventh, and thirteenth pages PAG0, PAG1, PAG3, PAG5, PAG7, PAG9, PAG11, and PAG13.

The memory controller Mctr may convert the logic address LADR into the physical address BK1-PG1 based on the metadata MD loaded to the volatile memory VLM. In this case, the memory controller Mctr manages the metadata MD so as to prevent the first process page PG1 of the first process block BK1 corresponding to the logic address LADR from becoming an MSB page. That is, when the first process block BK1 has the structure illustrated in FIGS. 5 and 6, the memory controller Mctr manages the metadata MD so as not to allow the first process page PG1 to become one of the second, fourth, sixth, eighth, tenth, twelfth, fourteenth, and fifteenth pages PAG2, PAG4, PAG6, PAG8, PAG10, PAG12, PAG14, and PAG15 that are MSB pages.

The memory controller Mctr may generate a write control signal WCON in response to the host's write request HWR. The write control signal WCON includes the physical address BK1-PG1 indicating the first process page PG1 in the first process block BK1, and the program data PDTA. The memory controller Mctr may access the first process page PG1 in the first process block BK1 of the flash memory MEM based on the write control signal WCON. The memory controller Mctr programs the first process page PG1 so as to store the program data PDTA in the first process page PG1 (S120).

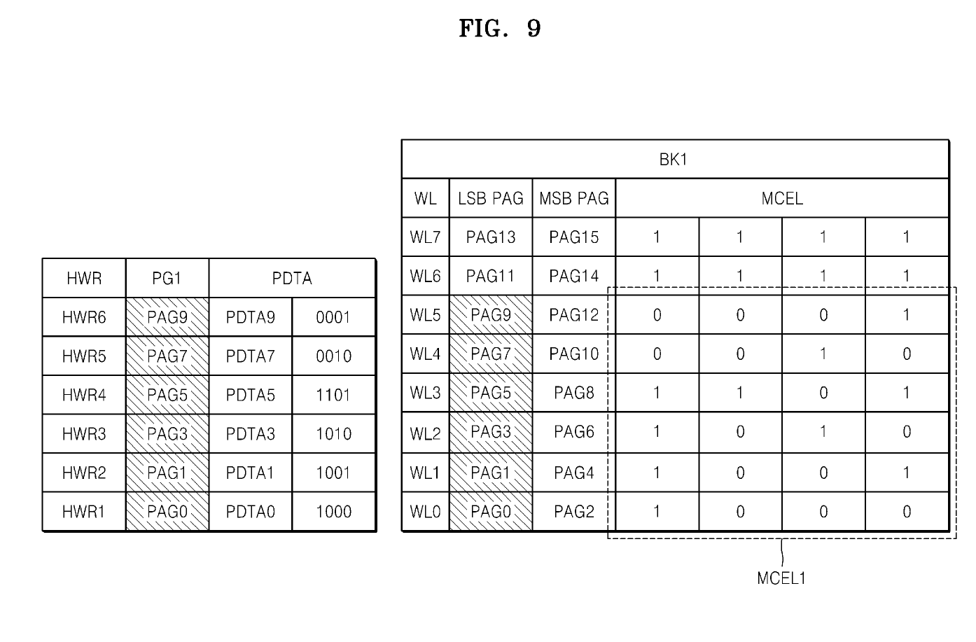

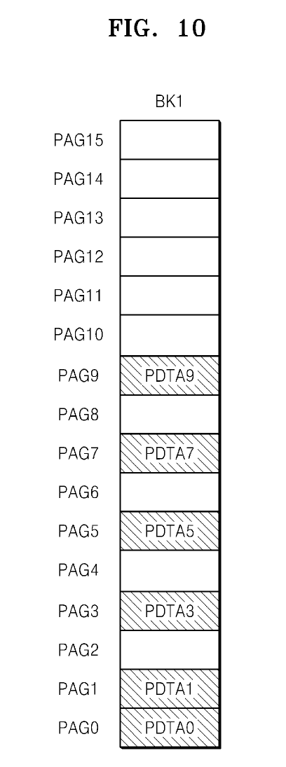

FIG. 9 illustrates tables for describing an example of a process for performing a program operation in the flash memory apparatus MEMA illustrated in FIG. 2 in response to multiple host's write requests, according to an embodiment of the inventive concept. FIG. 10 is a diagram showing a first process block including pages programmed in accordance with the tables illustrated in FIG. 9, according to an embodiment of the inventive concept.

In FIGS. 9 and 10, it is assumed that the first process block BK1 illustrated in FIG. 2 has the structure of the block BLK including multiple memory cells MCEL that are 2-bit MLCs, as illustrated in FIGS. 5 and 6. Also, it is assumed that the zeroth, first, third, fifth, seventh, and ninth pages PAG0, PAG1, PAG3, PAG5, PAG7, and PAG9 are programmed in response to first through sixth host's write requests HWR1 through HWR6.

Referring to FIGS. 9 and 10, a first process page PG1 for the first host's write request HWR1 is the zeroth page PAG0, which is an LSB page LSB PAG in the first process block BK1. A logic address included in the first host's write request HWR1 is mapped to the zeroth page PAG0, which is the LSB page LSB PAG in the first process block BK1. Zeroth program data PDTA0 included in the first host's write request HWR1 may be 4-bit information “1000”, for example.

The zeroth page PAG0 is the LSB page LSB PAG corresponding to the zeroth word line WL0. The zeroth page PAG0 is programmed to store information “1000” in response to the first host's write request HWR1. When the zeroth page PAG0 corresponds to four memory cells MCEL, the programmed four memory cells MCEL individually store 1-bit information (1, 0, 0, and 0).

A first process page PG1 for the second host's write request HWR2 is the first page PAG1, which is an LSB page LSB PAG corresponding to the first word line WL1. First program data PDTA1 of the second host's write request HWR2 may be 4-bit information “1001”, for example. The first page PAG1 is programmed to store information “1001”, and four memory cells MCEL corresponding to the first page PAG1 individually store 1-bit information (1, 0, 0, and 1).

A first process page PG1 for the third host's write request HWR3 is the third page PAG3, which is an LSB page LSB PAG corresponding to the second word line WL2. Third program data PDTA3 of the third host's write request HWR3 may be 4-bit information “1010”, for example. The third page PAG3 is programmed to store information “1010”, and four memory cells MCEL corresponding to the third page PAG3 may individually store 1-bit information (1, 0, 1, and 0).

The second page PAG2 is an MSB page MSB PAG corresponding to the zeroth word line WL0. The second page PAG2 is not programmed, but is skipped by the third host's write request HWR3. Accordingly, although the first process block BK1 includes multiple memory cells MCEL that are 2-bit MLCs, the memory cells MCEL corresponding to the zeroth page PAG0 individually store only 1-bit information.

In the same manner, according to the fourth through sixth host's write request HWR4 through HWR6, fifth, seventh, and ninth program data PDTA5, PDTA7, and PDTA9 are respectively programmed in the fifth, seventh, and ninth pages PAG5, PAG7, and PAG9 that are LSB pages LSB PAG.

In general, in a flash memory including multiple memory cells that are N-bit MLCs (where N is an integer greater than 1), M first process pages PG1 (where M is an integer greater than 0) (e.g., the zeroth, first, third, fifth, seventh, and ninth pages PAG0, PAG1, PAG3, PAG5, PAG7, and PAG9) are programmed in response to M host's write requests (e.g., the first through sixth host's write requests HWR1 through HWR6). All of the M first process pages PG1 are LSB pages LSB PAG. Hereinafter, from among the memory cells MCEL that are N-bit MLCs, memory cells MCEL corresponding to the M first process pages PG1 are referred to as a first memory cells MCEL1.

The first memory cells MCEL1 individually store 1-bit information because M×(N−1) pages (e.g., the second, fourth, sixth, eighth, tenth, and twelfth pages PAG2, PAG4, PAG6, PAG8, PAG10, and PAG12), which share the first memory cells MCEL1 with the M first process pages PG1, are not programmed.

In the first process block BK1, only multiple first process pages PG1 (e.g., the zeroth, first, third, fifth, seventh, and ninth pages PAG0, PAG1, PAG3, PAG5, PAG7, and PAG9) are programmed in response to the host's write requests (e.g., the first through sixth host's write requests HWR1 through HWR6). The first process pages PG1 of the first process block BK1 may be programmed in an ascending order of page numbers, and more particularly, in a discontinuously ascending order of page numbers. That is, when the first process block BK1 is programmed in an order of the zeroth page PAG0, the first page PAG1, the second page PAG2, and the third page PAG3, pages of the first process block BK1 would be programmed in a continuously ascending order of page numbers. However, since the second page PAG2, which is an MSB page MSB PAG, is not programmed in the first process block BK1, pages of the first process block BK1 are programmed in a discontinuously ascending order of page numbers. However, although the first process block BK1 is programmed in a discontinuously ascending order of page numbers, the first process block BK1 may be programmed in a continuously ascending order of word line numbers, i.e., an order of the zeroth word line WL0, the first word line WL1, and the second word line WL2, without departing from the scope of the present teachings.

In order to explain an effect of not programming an MSB page MSB PAG in response to the host's write request HWR, a case in which an MSB page MSB PAG is programmed in response to the host's write request HWR will now be described.

If power is suddenly cut off while programming an MSB page MSB PAG in response to the host's write request HWR, program data already stored in an LSB page LSB PAG, as well as program data to be stored in the MSB page MSB PAG, may be damaged. Accordingly, when the LSB page LSB PAG is read, program data different from the program data written in the LSB page LSB PAG may be read. This is referred to as an MSB page-LSB page interference phenomenon.

For example, it may be assumed that, after the zeroth program data PDTA0 is programmed in the zeroth page PAG0, which is an LSB page LSB PAG, power off occurs while programming the second page PAG2, which is an MSB page MSB PAG for forming a pair with the zeroth page PAG0. In this case, the zeroth program data PDTA0 already stored in the zeroth page PAG0, as well as program data to be stored in the second page PAG2, may be damaged. Also, since the program data PDTA included in the host's write request HWR is temporarily stored in the volatile memory VLM illustrated in FIG. 1, when power is cut off, the program data PDTA stored in the volatile memory VLM is erased. Accordingly, when program data stored in an LSB page LSB PAG is damaged due to the MSB page-LSB page interference phenomenon, the damaged program data may not be restored.

In order to address the MSB page-LSB page interference phenomenon, before the MSB page MSB PAG is programmed, program data stored in the LSB page LSB PAG may be backed up to another block. However, the backup causes unnecessary operational overhead in the flash memory apparatus MEMA.

According to an embodiment of the inventive concept, when only an LSB page LSB PAG is programmed and a corresponding MSB page MSB PAG is not programmed in response to the host's write request HWR, the MSB page-LSB page interference phenomenon does not occur, thus avoiding performance of unnecessary operations, such as a backup operation. Accordingly, data integrity may be ensured, and the reliability of the flash memory apparatus MEMA is improved without additional operational overhead.

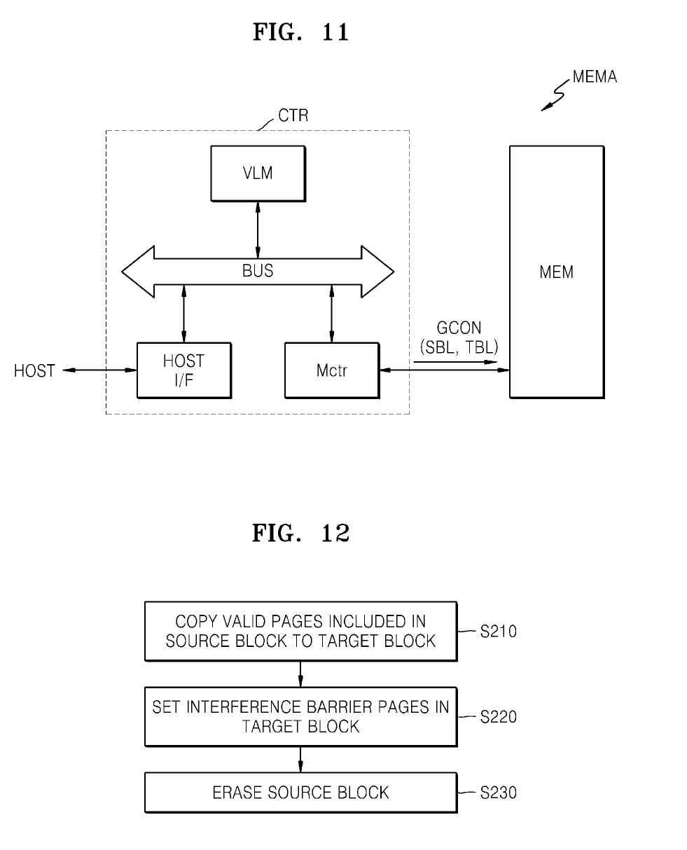

A garbage collection operation will now be described with reference to FIGS. 11 and 12. FIG. 11 is a diagram showing a garbage collection operation performed in the flash memory apparatus MEMA illustrated in FIG. 1, according to an embodiment of the inventive concept. FIG. 12 is a flowchart for describing an example of a process for performing a garbage collection operation in the flash memory apparatus MEMA illustrated in FIG. 11, according to an embodiment of the inventive concept.

Referring to FIGS. 11 and 12, the memory controller Mctr of the control unit CTR copies n valid pages (where n is an integer greater than 1) included in a source block SBL to a target block TBL in the flash memory MEM (S210). In this case, the n valid pages included in the source block SBL are copied to n continuous second process pages in the target block TBL.

The memory controller Mctr sets interference barrier pages including at least one page in the target block TBL (S220). When the interference barrier pages are set in the target block TBL, the memory controller Mctr erases the source block SBL (S230) because the n continuous second process pages in the target block TBL copied from the n valid pages of the source block SBL are protected due to the interference barrier pages. The erased source block SBL becomes a free block. The source block SBL is also referred to as a second process block, and the target block TBL is also referred to as a third process block.

The garbage collection operation may be preformed in response to a garbage collection control signal GCON. The garbage collection control signal GCON may include information indicating the source block SBL and the target block TBL.

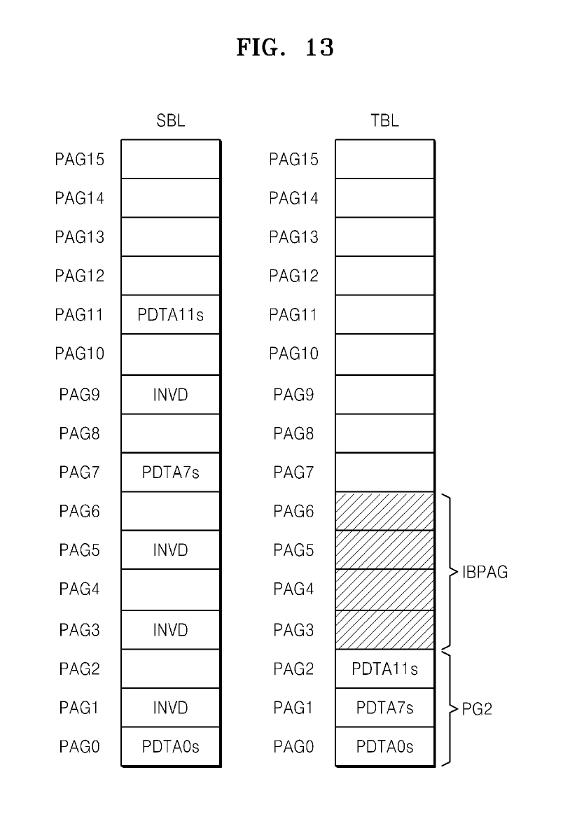

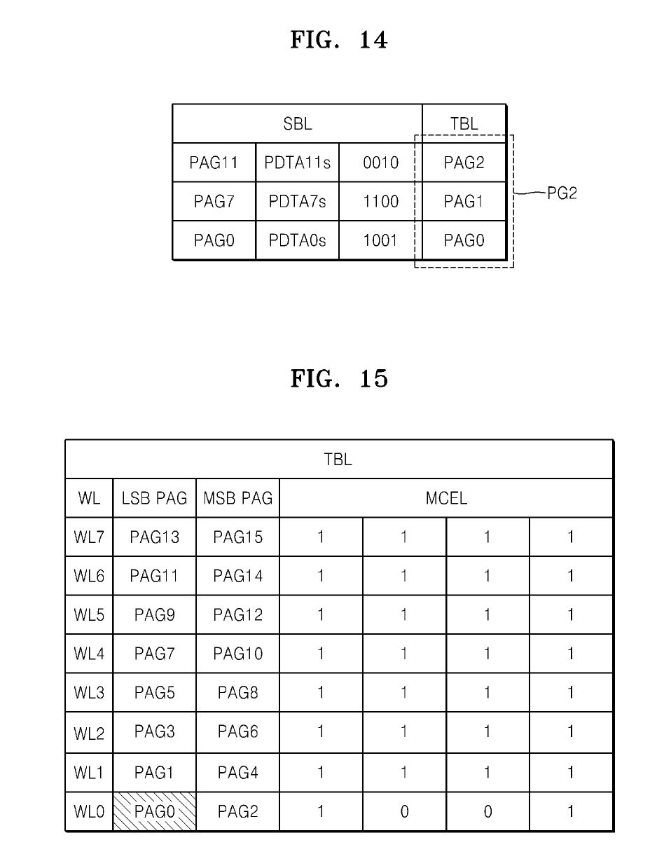

FIG. 13 is a diagram showing an example of a source block SBL and a target block TBL on which a garbage collection operation is performed in the flash memory apparatus MEMA illustrated in FIG. 11, according to an embodiment of the inventive concept. FIG. 14 is a table showing correspondence between valid pages of the source block SBL and pages of the target block TBL illustrated in FIG. 13, according to an embodiment of the inventive concept. FIGS. 15 through 17 are tables showing a process for programming the target block TBL illustrated in FIG. 13 in accordance with the table illustrated in FIG. 14, according to an embodiment of the inventive concept. In FIGS. 13 through 17, it is assumed that the source block SBL and the target block TBL have the same structure as the block BLK, including multiple memory cells MCEL, which are 2-bit MLCs, as illustrated in FIGS. 5 and 6.

Referring to FIG. 13, the source block SBL includes multiple programmed pages, e.g., the zeroth, first, third, fifth, seventh, ninth, and eleventh pages PAG0, PAG1, PAG3, PAG5, PAG7, PAG9, and PAG11. From among the programmed zeroth, first, third, fifth, seventh, ninth, and eleventh pages PAG0, PAG1, PAG3, PAG5, PAG7, PAG9, and PAG11 in the source block SBL, the zeroth, seventh, and eleventh pages PAG0, PAG7, and PAG11 may be valid pages in which valid zeroth, seventh, and eleventh program data PDTA0s, PDTA7s, and PDTA11s are respectively stored, and the first, third, fifth, and ninth pages PAG1, PAG3, PAG5, and PAG9 may be invalid pages in which invalid data INVD are stored, for example.

An invalid page refers to a page in which invalid data INVD is stored, and thus new program data is not writable thereto. The invalid pages of the source block SBL may be generated due to characteristics of the flash memory MEM of FIG. 11. For example, after primary program data is programmed in the first page PAG1 of the source block SBL, a host's write request may be generated, indicating update data of the primary program data be written. In this case, when the first page PAG1 in which the primary program data is stored is not erased, the update data may not be written into the first page PAG1. Since an erase operation is performed in block units, the flash memory apparatus MEMA of FIG. 11 may not directly erase the source block SBL, and may allocate a new page instead of the first page PAG1 for programming the update data. In this case, the primary program data stored in the first page PAG1 becomes invalid data INVD.

The zeroth, first, third, fifth, seventh, ninth, and eleventh pages PAG0, PAG1, PAG3, PAG5, PAG7, PAG9, and PAG11 in the source block SBL may be pages programmed in response to host's write requests. In this case, all of the zeroth, first, third, fifth, seventh, ninth, and eleventh pages PAG0, PAG1, PAG3, PAG5, PAG7, PAG9, and PAG11 in the source block SBL are LSB pages LSB PAG (see FIG. 6). However, the case illustrated in FIG. 13 is merely an example, and all programmed pages in the source block SBL are not limited to the LSB pages LSB PAG.

The target block TBL may be an erased block before the garbage collection operation is performed, that is, before the zeroth, seventh, and eleventh pages PAG0, PAG7, and PAG11 of the source block SBL are copied.

The zeroth, seventh, and eleventh program data PDTA0s, PDTA7s, and PDTA11s stored in n valid pages, e.g., the zeroth, seventh, and eleventh pages PAG0, PAG7, and PAG11, included in the source block SBL are copied to n continuous pages, e.g., the zeroth through second pages PAG0 through PAG2, in the target block TBL. The zeroth through second pages PAG0 through PAG2 in the target block TBL are pages having continuous page numbers, and may include LSB pages LSB PAG (the zeroth and first pages PAG0 and PAG1) and an MSB page MSB PAG (the second page PAG2). That is, when the garbage collection operation is performed, both LSB and MSB pages LSB PAG and MSB PAG are programmed in the target block TBL. Hereinafter, the n continuous pages in the target block TBL are also referred to as multiple second process pages PG2.

Referring to FIGS. 13 and 14, the n valid pages included in the source block SBL respectively correspond to the n continuous second process pages PG2 in the target block. For example, the seventh program data PDTA7s, e.g., “1100”, is stored in the seventh page PAG7 of the source block SBL, and is copied to the first page PAG1 of the target block TBL.

However, the case illustrated in FIGS. 13 and 14 is merely an example, and correspondence between the n valid pages included in the source block SBL and the n continuous second process pages PG2 in the target block TBL are not limited thereto. Also, although all of the n valid pages of the source block SBL are copied to the target block TBL in FIGS. 13 and 14, the n valid pages of the source block SBL may be copied to different target blocks, without departing from the scope of the present teachings.

Referring to FIGS. 13 through 17, the second process pages PG2 of the target block TBL are programmed in a continuously ascending order of page numbers. Accordingly, the target block TBL is programmed in an order of the zeroth page PAG0, the first page PAG1, and the second page PAG2. Since the target block TBL is in an erased state before being programmed, all memory cells MCEL of the target block TBL initially store information of “1”.

As illustrated in FIG. 15, the zeroth page PAG0, i.e., an LSB page LSB PAG, of the target block TBL is programmed to store information “1001”, for example, which is the zeroth program data PDTA0s stored in the zeroth page PAG0 of the source block SBL. When the zeroth page PAG0 of the target block TBL corresponds to four memory cells MCEL, the four memory cells MCEL individually store 1-bit information (1, 0, 0, and 1) when the zeroth page PAG0 is programmed.

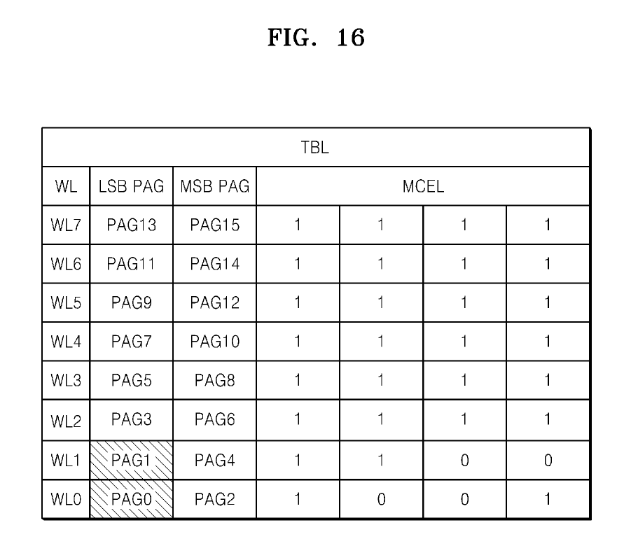

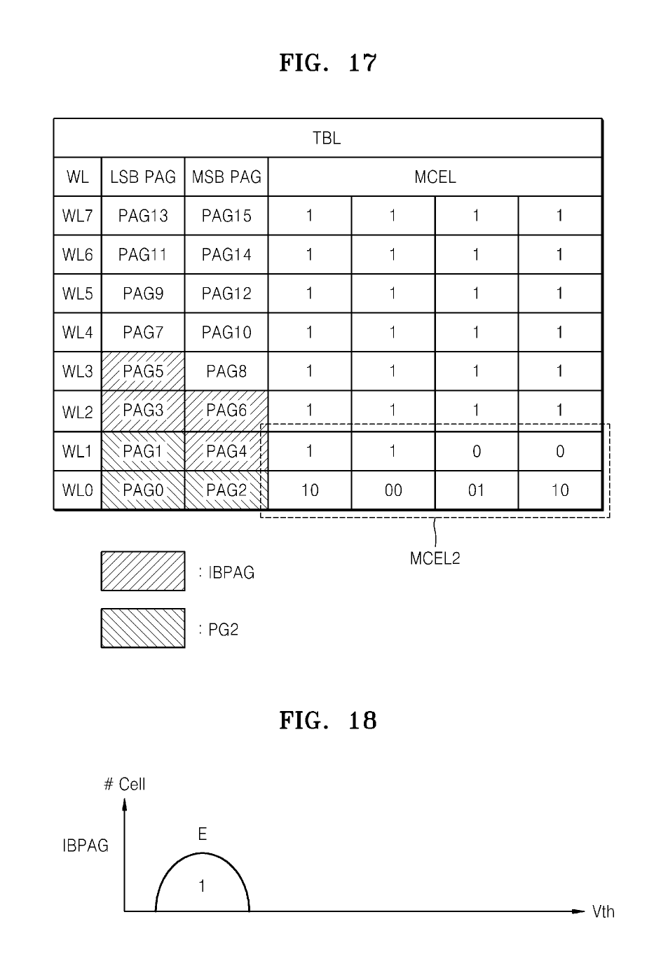

Then, as illustrated in FIG. 16, the first page PAG1, i.e., an LSB page LSB PAG, of the target block TBL is programmed to store information of “1100”, for example, which is the seventh program data PDTA7s stored in the seventh page PAG7 of the source block SBL. Four memory cells MCEL corresponding to the first page PAG1 of the target block TBL may individually store 1-bit information (1, 1, 0, and 0).

Then, as illustrated in FIG. 17, the second page PAG2, i.e., an MSB page MSB PAG, of the target block TBL is programmed to store information of “0010”, which is the eleventh program data PDTA11s stored in the eleventh page PAG11 of the source block SBL. In this case, the second page PAG2, which is an MSB page MSB PAG, forms a pair with the zeroth page PAG0, which is an LSB page LSB PAG, and corresponds to the zeroth word line WL0. After the zeroth page PAG0 of the target block TBL is programmed (see FIG. 15), if the second page PAG2 is programmed, four memory cells MCEL corresponding to the zeroth and second PAG0 and PAG2 of the target block TBL may individually store 2-bit information (10, 00, 01, and 10). In the memory cell MCEL representing “01”, the LSB “0” is information regarding the zeroth page PAG0, which is an LSB page, and MSB “1” is information regarding the second page PAG2, which is an MSB page.

From among the multiple memory cells MCEL included in the target block TBL, the memory cells corresponding to the second process pages PG2 are referred to as second memory cells MCEL2. After a garbage collection operation is performed, in the target block TBL including multiple memory cells MCEL that are 2-bit MLCs, each of the second memory cells MCEL2 store 1-bit or 2-bit information.

In general, after a garbage collection operation is performed, each of the second memory cells MCEL2 in the target block TBL may store p-bit information (p=1, 2, . . . , N), the target block TBL including memory cells MCEL that are N-bit MLCs (where N is an integer greater than 1).

In a programming operation using a garbage collection operation, unlike a programming operation in response to a host's write request, an MSB (e.g., the second page PAG2) in the target block TBL is also programmed. In the garbage collection operation, while copying valid pages, e.g., the zeroth, seventh, and eleventh pages PAG0, PAG7, and PAG11, of the source block SBL, to the target block TBL, although an MSB page-LSB page interference phenomenon occurs, original program data (the zeroth, seventh, and eleventh program data PDTA0s, PDTA7s, and PDTA11s) are stored in the source block SBL. For example, after the zeroth program data PDTA0s is programmed in the zeroth page PAG0, i.e., an LSB page LSB PAG, in the target block TBL, the zeroth program data PDTA0s stored in the zeroth page PAG0 may be damaged while programming the second page PAG2, i.e., an MSB page MSB PAG, in the target block TBL. However, since the zeroth program data PDTA0s remains in the zeroth page PAG0 of the source block SBL, the zeroth program data PDTA0s damaged in the target block TBL may be restored.

Also, although all of the zeroth, first, third, fifth, seventh, ninth, and eleventh pages PAG0, PAG1, PAG3, PAG5, PAG7, PAG9, and PAG11 programmed in the source block SBL are LSB pages LSB PAG, since continuous second process pages PG2 are programmed in the target block TBL by performing the garbage collection operation, both LSB and MSB pages LSB PAG and MSB PAG may be programmed. Accordingly, although only LSB pages LSB PAG are programmed in response to host's write requests, both LSB and MSB pages LSB PAG and MSB PAG may be used by performing the garbage collection operation. As such, the efficiency of MLC storing capacity is maintained.

After the n valid pages included in the source block SBL are copied to the n continuous second process pages PG2 in the target block TBL, the third through sixth pages PAG3 through PAG6 of the target block TBL are set as interference barrier pages IBPAG. The third through sixth pages PAG3 through PAG6 set as interference barrier pages IBPAG in the target block TBL are not programmed. The interference barrier pages IBPAG are set to prevent damage of program data due to word line bridges between neighboring word lines.

From among multiple word lines, e.g., the zeroth through first word lines WL0 through WL1, corresponding to the second process pages PG2 in the target block TBL, i.e., an ith page (where i is an integer equal to or greater than 0) (e.g., the zeroth page PAG0, i=0) through an (i+n−1)th page (e.g., the second page PAG2, i=0, n=3), a word line having the highest word line number is referred to as an mth word line (where m is an integer equal to or greater than 0) (e.g., the first word line WL1). The interference barrier pages IBPAG may include an (i+n)th page (e.g., the third page PAG3, i=0, n=3) through a kth page (where k is an integer greater than i+n−1) (e.g., the sixth page PAG6) that is an MSB page corresponding to an (m+1)th word line (e.g., the second word line WL2). After the garbage collection operation is completed between the source block SBL and the target block TBL, the target block TBL may be programmed from a (k+1)th page (e.g., the seventh page PAG7) adjacent to the interference barrier pages IBPAG (e.g., the third through sixth pages PAG3 through PAG6).

In order to explain an effect of setting the interference barrier pages IBPAG, a case in which the interference barrier pages IBPAG are not set is first described. When the interference barrier pages IBPAG are not set, after a garbage collection operation is completed between the source block SBL and the target block TBL, the source block SBL may be erased and the target block TBL may be programmed from the third page PAG3. While programming the fourth page PAG4, i.e., an MSB page MSB PAG, of the target block TBL, program data of the first page PAG1 may be damaged due to the MSB page-LSB page interference phenomenon. Also, while programming the fourth page PAG4 of the first word line WL1, program data of the zeroth, second, and third pages PAG0, PAG2, and PAG3 corresponding to the zeroth and second word lines WL0, WL2 adjacent to the first word line WL1 may be damaged due to word line bridges. In particular, the zeroth and eleventh program data PDTA0s and PDTA11s of the valid zeroth and eleventh pages PAG0 and PAG11 of the source block SBL are stored in the zeroth and second pages PAG0 and PAG2 of the target block TBL. However, since the source block SBL is erased when the garbage collection operation is completed, if the zeroth and second pages PAG0 and PAG2 of the target block TBL are damaged due to word line bridges after the garbage collection is performed, the zeroth and eleventh program data PDTA0s and PDTA11s may not be restored.

In comparison, when the interference barrier pages IBPAG are set according to an embodiment of the inventive concept, the second process pages PG2 of the target block TBL copied from the n valid pages of the source block SBL are prevented from being damaged. The target block TBL is programmed from the seventh page PAG7 adjacent to the interference barrier pages IBPAG. When the eighth page PAG8, which is an MSB page MSB PAG corresponding to the third word line WL3, is programmed, the second process pages PG2 are not damaged due to word line bridges because the third word line WL3 corresponding to the eighth page PAG8 is not adjacent to the zeroth and first word lines WL0 and WL1 corresponding to the second process pages PG2.

FIG. 18 is a graph showing an example of a dispersion of memory cells corresponding to LSB pages from among the interference barrier pages IBPAG illustrated in FIG. 17 after a garbage collection operation is performed, according to an embodiment of the inventive concept. In FIG. 18, it is assumed that the third through sixth pages PAG3 through PAG6, set as the interference barrier pages IBPAG in the target block TBL, are not programmed.

Referring to FIGS. 17 and 18, since the interference barrier pages IBPAG are not programmed, all memory cells corresponding to LSB pages LSB PAG (i.e., the third and fifth pages PAG3 and PAG5) from among the interference barrier pages IBPAG are in an erase state E. As described above, when the interference barrier pages IBPAG are not programmed, the second word line WL2 is not programmed in the target block TBL. That is, when the interference barrier pages IBPAG are set, a word line (e.g., the second word line WL2) that is skipped and is not programmed is generated in the target block TBL.

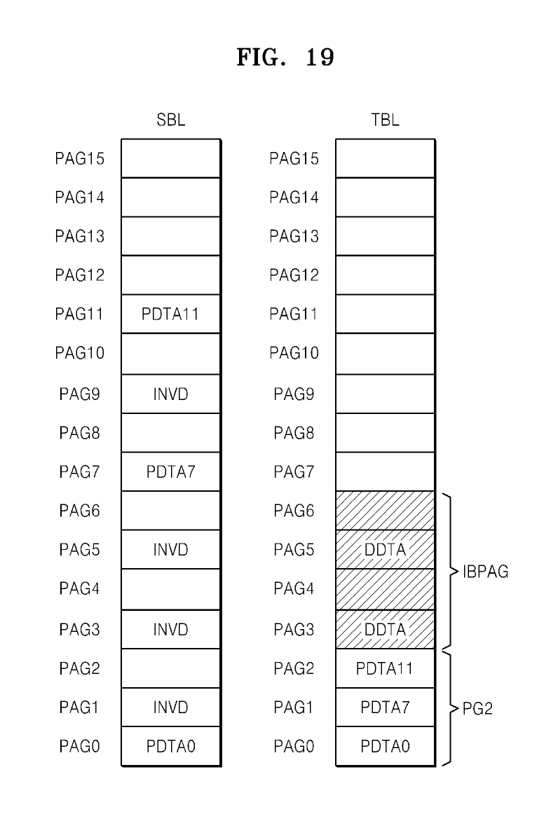

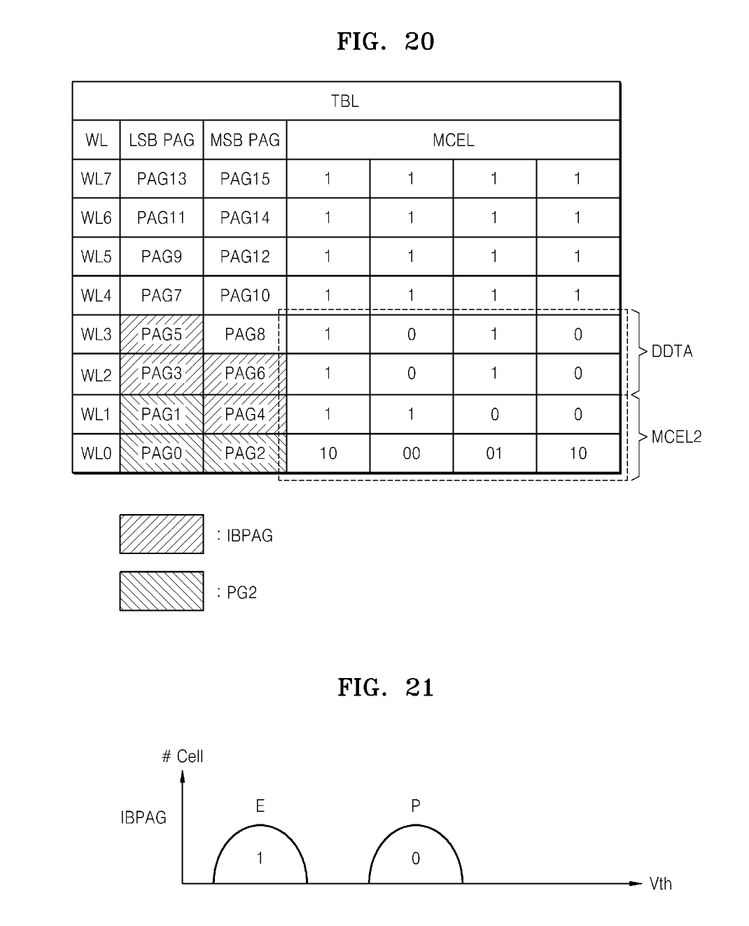

FIG. 19 is a diagram showing another example of a source block SBL and a target block TBL on which a garbage collection operation is performed in the flash memory apparatus MEMA illustrated in FIG. 11, according to an embodiment of the inventive concept. FIG. 20 is a table showing an example of the target block TBL illustrated in FIG. 19, according to an embodiment of the inventive concept.

Referring to FIGS. 19 and 20, dummy data DDTA are programmed in the third and fifth pages PAG3 and PAG5, which are LSB pages LSB PAG, from among the interference barrier pages IBPAG. Except for the dummy data DDTA, the descriptions provided above in relation to FIGS. 13 and 17 may also be applied to FIGS. 19 and 20, and thus will not be repeated.

The dummy data DDTA may be previously set by the memory controller Mctr, and is shown as “1010”, for example. The third and fifth pages PAG3 and PAG5, which are LSB pages LSB PAG from among the interference barrier pages IBPAG, are programmed to store the dummy data DDTA information “1010”. Four memory cells MCEL corresponding to LSB pages LSB PAG (e.g., the third and fifth pages PAG3 and PAG5) from among the interference barrier pages IBPAG may individually store 1-bit information (1, 0, 1, and 0).

FIG. 21 is a graph showing an example of a dispersion of memory cells corresponding to LSB pages from among the interference barrier pages IBPAG illustrated in FIG. 19 after a garbage collection operation is performed, according to an embodiment of the inventive concept. In FIG. 21, it is assumed that the dummy data DDTA is programmed in LSB pages LSB PAG (e.g., the third and fifth pages PAG3 and PAG5) from among the interference barrier pages IBPAG in the target block TBL.

Referring to FIGS. 19 through 21, since the dummy data DDTA is programmed in LSB pages LSB PAG from among the interference barrier pages IBPAG, each of memory cells corresponding to the LSB pages LSB PAG may represent a cell dispersion of an erase state E or a program state P. As described above, when the dummy data DDTA is programmed in LSB pages LSB PAG from among the interference barrier pages IBPAG, a word line is not skipped (or not programmed) in the target block TBL.

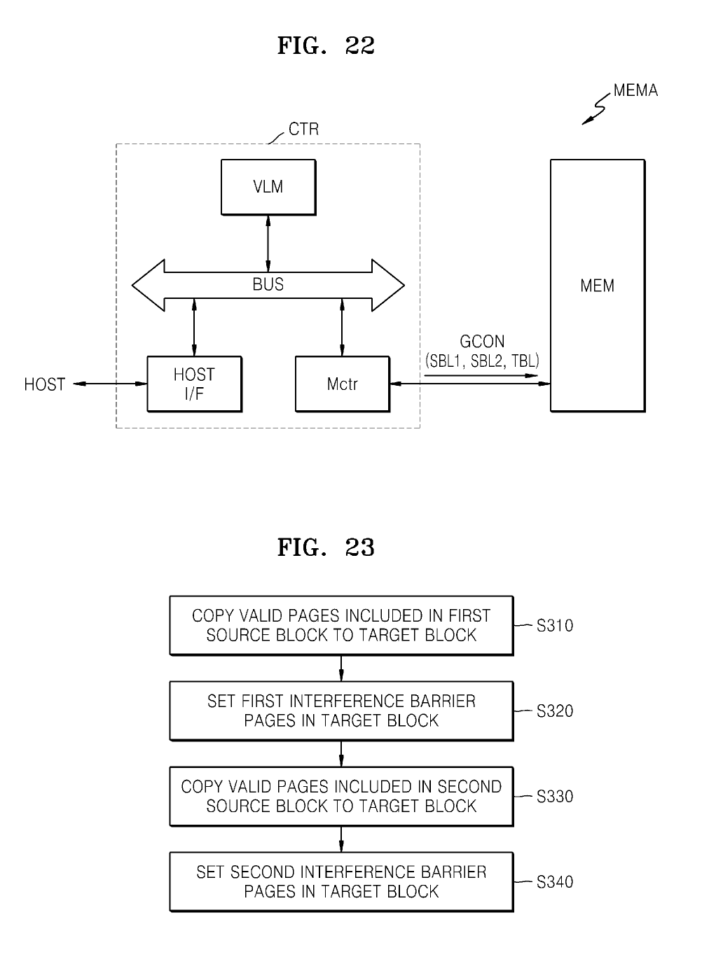

FIG. 22 is a diagram showing a garbage collection operation performed in the flash memory apparatus MEMA illustrated in FIG. 1, according to another embodiment of the inventive concept. FIG. 23 is a flowchart for describing an example of a process for performing a garbage collection operation in the flash memory apparatus MEMA illustrated in FIG. 22, according to an embodiment of the inventive concept.

Referring to FIGS. 22 and 23, the memory controller Mctr of the flash memory apparatus MEMA copies n valid pages (where n is an integer greater than 1) included in a first source block SBL1 to a target block TBL in the flash memory MEM (S310). In this case, the n valid pages included in the first source block SBL1 are copied to n continuous second process pages in the target block TBL. The memory controller Mctr sets first interference barrier pages including at least one page in the target block TBL (S320). The descriptions provided above in relation to operations S210 and S220 illustrated in FIG. 12 may also be applied to operations S310 and S320, and thus will not be repeated.

The memory controller Mctr copies valid pages included in a second source block SBL2 to the target block TBL (S330). The memory controller Mctr sets second interference barrier pages including at least one page in the target block TBL (S340). When the first interference barrier pages are set in the target block TBL, the memory controller Mctr may erase the first source block SBL1. Also, when the second interference barrier pages are set in the target block TBL, the memory controller Mctr may erase the second source block SBL2.

A garbage collection operation may be performed based on a garbage collection control signal GCON. The garbage collection control signal GCON includes information indicating the first and second source blocks SBL1 and SBL2 and the target block TBL. The first source block SBL1 may also be referred to as a second process block, the target block TBL may also be referred to as a third process block, and the second source block SBL2 may also be referred to as a fourth process block.

Although the garbage collection operation is performed based on one garbage collection control signal GCON in FIG. 22, the case illustrated in FIG. 22 is merely an example. As another example, initially, the garbage collection operation may be performed between the first source block SBL1 and the target block TBL based on a first garbage collection control signal including information indicating the first source block SBL1 and the target block TBL. Then, the garbage collection operation may be performed between the second source block SBL2 and the target block TBL based on a second garbage collection control signal including information indicating the second source block SBL2 and the target block TBL.

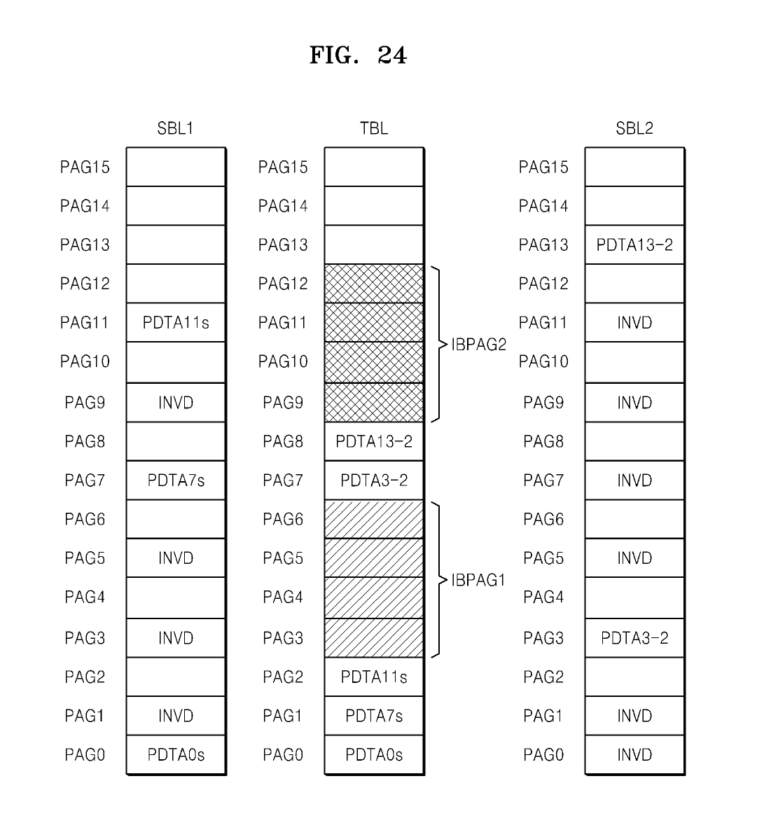

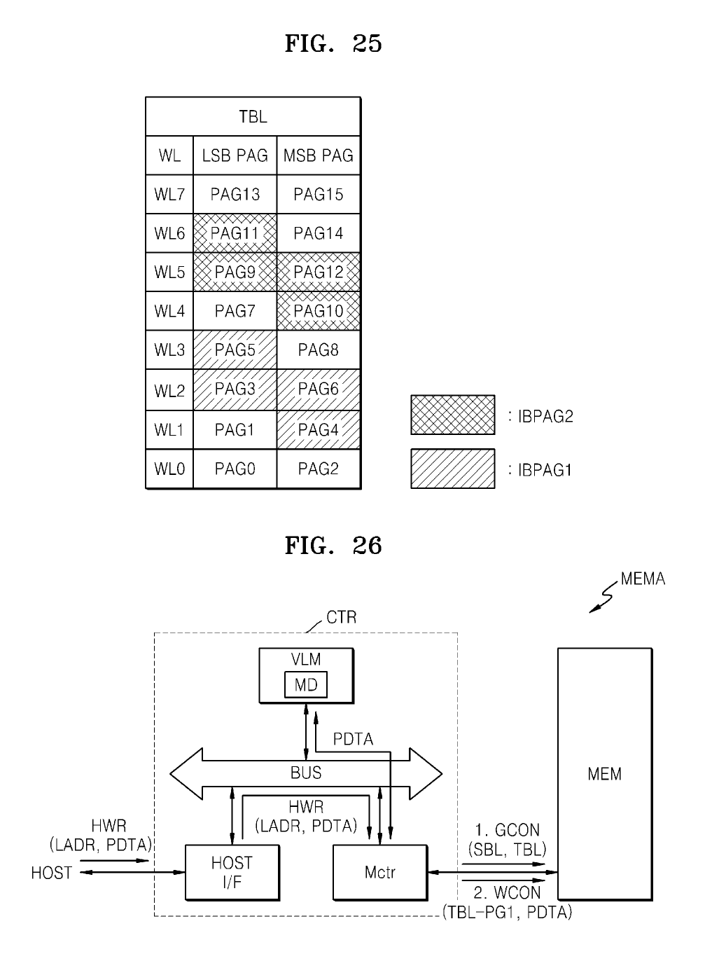

FIG. 24 is a diagram showing an example of the first and second source blocks SBL1 and SBL2 and the target block TBL on which a garbage collection operation is performed in the flash memory apparatus MEMA illustrated in FIG. 22, according to an embodiment of the inventive concept. FIG. 25 is a diagram showing an example of LSB and MSB pages corresponding to multiple word lines in the target block TBL illustrated in FIG. 24, according to an embodiment of the inventive concept. In FIGS. 24 and 25, it is assumed that the first and second source blocks SBL1 and SBL2 and the target block TBL have the structure of the block BLK, including multiple memory cells MCEL that are 2-bit MLCs, as illustrated in FIGS. 5 and 6.

Referring to FIGS. 24 and 25, the zeroth, seventh, and eleventh program data PDTA0s, PDTA7s, and PDTA11s stored in n valid pages, e.g., the zeroth, seventh, and eleventh pages PAG0, PAG7, and PAG11, included in the first source block SBL1 are copied to n continuous pages, e.g., the zeroth through second pages PAG0 through PAG2, in the target block TBL. After the n valid pages of the first source block SBL1 are copied, the third through sixth pages PAG3 through PAG6 of the target block TBL are set as first interference barrier pages IBPAG1. The descriptions provided above in relation to FIG. 13 may also be applied for setting the first interference barrier pages IBPAG1, and thus will not be repeated.

Third and thirteenth program data PDTA3-2 and PDTA13-2 stored in valid pages, e.g., the third and thirteenth pages PAG3 and PAG13, included in the second source block SBL2 are copied to continuous pages, e.g., the seventh and eighth pages PAG7 and PAG8, in the target block TBL. In this case, the valid pages of the second source block SBL2 may be copied to pages from the seventh page PAG7 adjacent to the first interference barrier pages IBPAG1 in the target block TBL.

After the valid pages of the second source block SBL2 are copied, the ninth through twelfth pages PAG9 through PAG12 of the target block TBL are set as second interference barrier pages IBPAG2. From among multiple word lines, e.g., the third and fourth word lines WL3 and WL4, corresponding to the seventh and eighth pages PAG7 and PAG8 of the target block TBL copied from the valid pages of the second source block SBL2, the word line having the highest word line number is the fourth word line WL4. Accordingly, pages from the ninth page PAG9 to the twelfth page PAG12, which is an MSB page MSB PAG of the fifth word line WL5 are set as the second interference barrier pages IBPAG2. After the garbage collection operation is completed between the first and second source blocks SBL1 and SBL2 and the target block TBL, the target block TBL may be programmed from the thirteenth page PAG13 adjacent the second interference barrier pages IBPAG2.

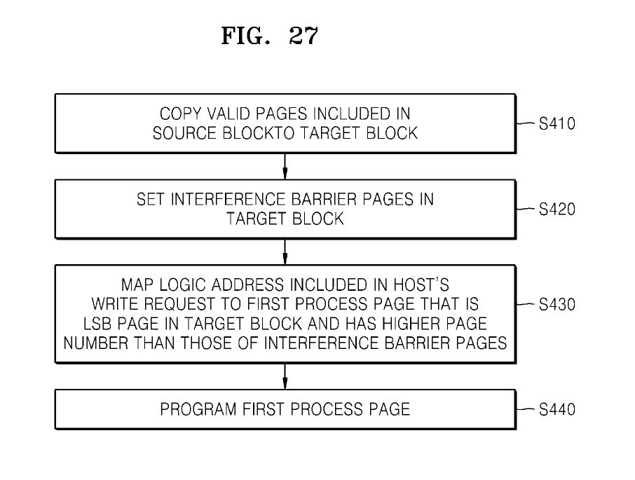

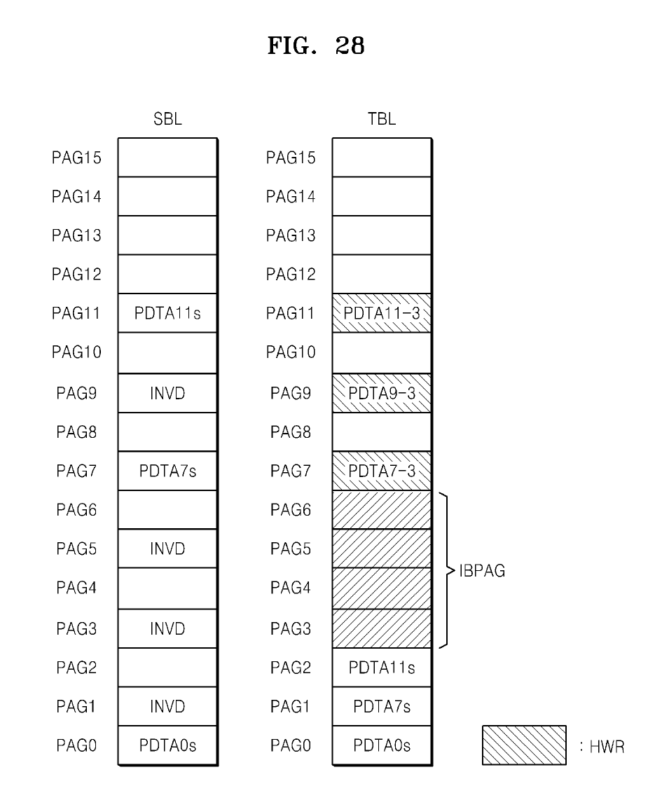

FIG. 26 is a diagram showing an operation performed in the flash memory apparatus MEMA illustrated in FIG. 1, according to another embodiment of the inventive concept. FIG. 27 is a flowchart for describing an example of a process for performing an operation in the flash memory apparatus MEMA illustrated in FIG. 26.

Referring to FIGS. 26 and 27, the memory controller Mctr of the flash memory apparatus MEMA copies n valid pages (where n is an integer greater than 1) included in the source block SBL to the target block TBL in the flash memory MEM (S410). The memory controller Mctr sets interference barrier pages in the target block TBL (S420). The descriptions provided above in relation to operations S210 and S220 illustrated in FIG. 12 may also be applied to operations S410 and S420, and thus will not be repeated.

The memory controller Mctr maps the logic address LADR included in the host's write request HWR to the first process page PG1 that is an LSB page in the target block TBL (S430). In this case, the first process page PG1 is an LSB page having a higher page number than those of the interference barrier pages in the target block TBL. The memory controller Mctr programs the first process page PG1 (S440). In FIG. 27, the descriptions provided above in relation to operations S110 and operation S120 illustrated in FIG. 3 may also be applied to operations S430 and S440, and thus will not be repeated. However, the process illustrated in FIG. 27 is different from the process illustrated in FIG. 3 in that the first process block BK1 is the target block TBL and that a page number of the first process page PG1 is greater than those of the interference barrier pages in the target block TBL.

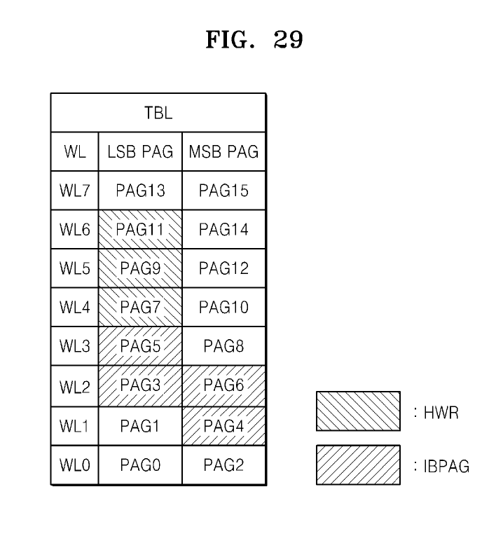

FIG. 28 is a diagram showing an example of the source block SBL and the target block TBL on which an operation is performed in the flash memory apparatus MEMA illustrated in FIG. 26, according to an embodiment of the inventive concept. FIG. 29 is a diagram showing an example of LSB and MSB pages corresponding to multiple word lines in the target block TBL illustrated in FIG. 28, according to an embodiment of the inventive concept.

In FIGS. 28 and 29, it is assumed that the source block SBL and the target block TBL have the structure of the block BLK including multiple memory cells MCEL, which are 2-bit MLCs, for example, as illustrated in FIGS. 5 and 6.

Referring to FIGS. 28 and 29, the zeroth, seventh, and eleventh program data PDTA0s, PDTA7s, and PDTA11s stored in n valid pages, e.g., the zeroth, seventh, and eleventh pages PAG0, PAG7, and PAG11, included in the source block SBL are copied to n continuous pages, e.g., the zeroth through second pages PAG0 through PAG2, in the target block TBL. After the n valid pages of the source block SBL are copied, the third through sixth pages PAG3 through PAG6 of the target block TBL are set as the interference barrier pages IBPAG. The description provided above in relation to FIG. 13 may also be applied through setting the interference barrier pages IBPAG, and thus will not be repeated.

The target block TBL is programmed from the seventh page PAG7 adjacent to the interference barrier pages IBPAG. In the target block TBL, seventh, ninth, and eleventh program data PDTA7-3, PDTA9-3, and PDTA11-3 are respectively programmed in the seventh, ninth, and eleventh pages PAG7, PAG9, and PAG11, which are LSB pages LSB PAG, in response to multiple host's write requests HWR. All of the seventh, ninth, and eleventh pages PAG7, PAG9, and PAG11 corresponding to multiple first process pages PG1 (see FIG. 26) regarding the host's write requests HWR have higher page numbers than those of the interference barrier pages IBPAG.

Cases in which the flash memory MEM of the flash memory apparatus MEMA includes 2-bit MLCs are mainly described above. However, the above-described flash memory apparatus MEMA and the above-described operation methods of the flash memory apparatus MEMA may also be applied to cases in which the flash memory apparatus MEMA includes 3-or-more-bit MLCs.

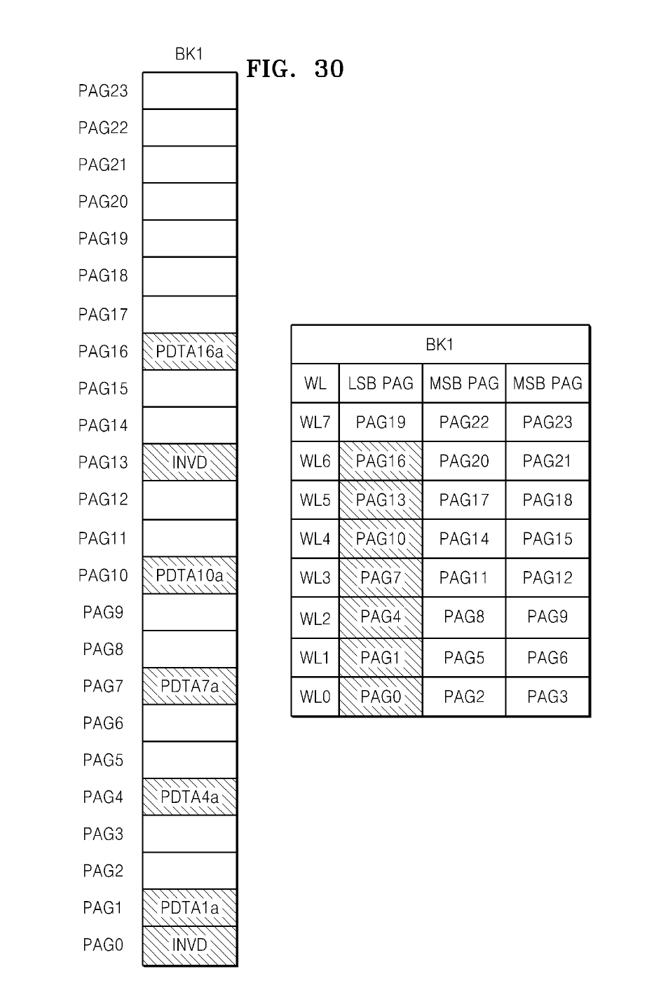

FIG. 30 is a diagram showing an example of the first process block BK1 including pages programmed in response to multiple host's write requests in the flash memory apparatus MEMA illustrated in FIG. 2, and LSB, CSB, and MSB pages corresponding to multiple word lines in the first process block BK1, according to an embodiment of the inventive concept. In FIG. 30, it is assumed that the first process block BK1 corresponds to the zeroth through seventh word lines WL0 through WL7, and includes multiple memory cells that are 3-bit MLCs.

Referring to FIG. 30, one word line in the first process block BK1 corresponds to three pages of an LSB page LSB PAG, a CSB page CSB PAG, and an MSB page MSB PAG. That is, one word line corresponds to a page group including three pages of an LSB page LSB PAG, a CSB page CSB PAG, and an MSB page MSB PAG. For example, the second word line WL2 of the first process block BK1 corresponds to one page group including the fourth page PAG4 as an LSB page LSB PAG, the eighth page PAG8 as a CSB page CSB PAG, and the ninth page PAG9 as an MSB page MSB PAG. The LSB page LSB PAG may also be referred to as a first bit page, and the MSB page MSB PAG and the CSB page CSB PAG may also be referred to as second bit pages. That is, one word line corresponds to one first bit page and at least one second bit page. However, the case illustrated in FIG. 30 is merely an example, and LSB, CSB, and MSB pages LSB PAG, CSB PAG, and MSB PAG corresponding to the zeroth through seventh word lines WL0 through WL7 are not limited thereto.

The first process block BK1 includes multiple pages, e.g., the zeroth, first, fourth, seventh, tenth, thirteenth, and sixteenth pages PAG0, PAG1, PAG4, PAG7, PAG10, PAG13, and PAG16, programmed in response to multiple host's write requests. Accordingly, all of the programmed zeroth, first, fourth, seventh, tenth, thirteenth, and sixteenth pages PAG0, PAG1, PAG4, PAG7, PAG10, PAG13, and PAG16 are LSB pages LSB PAG. From among the programmed zeroth, first, fourth, seventh, tenth, thirteenth, and sixteenth pages PAG0, PAG1, PAG4, PAG7, PAG10, PAG13, and PAG16 in the first process block BK1, the first, fourth, seventh, tenth, and sixteenth pages PAG1, PAG4, PAG7, PAG10, and PAG16 may be valid pages in which valid first, fourth, seventh, tenth, and sixteenth program data PDTA1a, PDTA4a, PDTA7a, PDTA10a, and PDTA16a are respectively stored, and the zeroth and thirteenth pages PAG0 and PAG13 may be invalid pages in which invalid data INVD are stored.

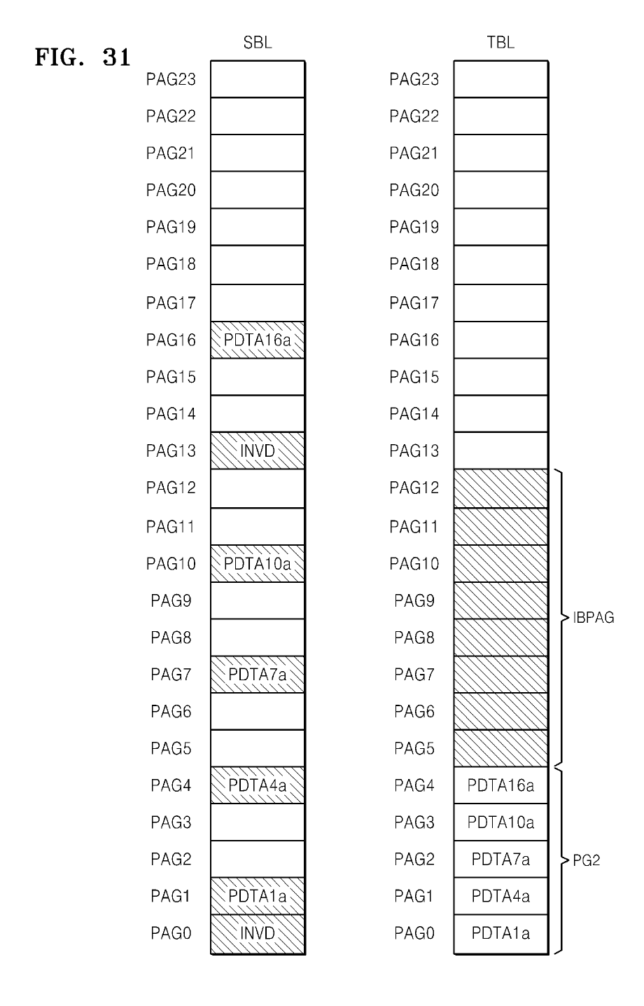

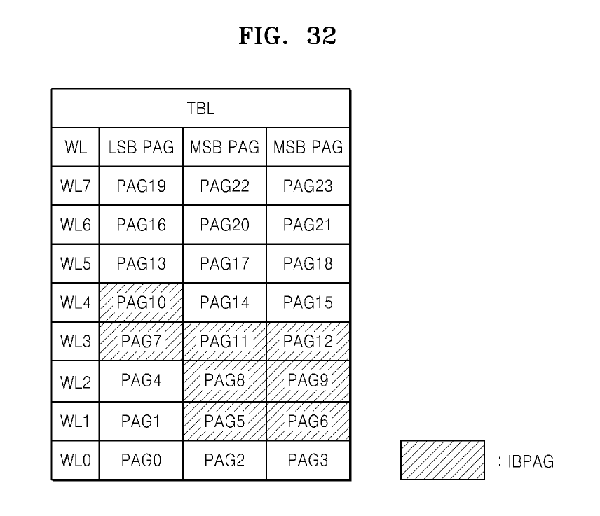

FIG. 31 is a diagram showing another example of blocks on which a garbage collection operation is performed in the flash memory apparatus MEMA illustrated in FIG. 11, according to an embodiment of the inventive concept. FIG. 32 is a diagram showing an example of LSB, CSB, and MSB pages corresponding to multiple word lines in the target block TBL illustrated in FIG. 31, according to an embodiment of the inventive concept.

In FIGS. 31 and 32, it is assumed that the source block SBL and the target block TBL include multiple memory cells that are 3-bit MLCs. Also, it is assumed for convenience of explanation that the source block SBL is the same as the first process block BK1 illustrated in FIG. 30, for example, the source block SBL is not limited thereto.

Referring to FIGS. 31 and 32, valid first, fourth, seventh, tenth, and sixteenth program data PDTA1a, PDTA4a, PDTA7a, PDTA10a, and PDTA16a stored in n valid pages, e.g., the first, fourth, seventh, tenth, and sixteenth pages PAG1, PAG4, PAG7, PAG10, and PAG16, included in the source block SBL are copied to n continuous second process pages PG2, e.g., the zeroth through fourth pages PAG0 through PAG4, in the target block TBL. After the n valid pages of the source block SBL are copied, the fifth through twelfth pages PAG5 through PAG12 of the target block TBL are set as the interference barrier pages IBPAG. From among multiple word lines, e.g., the zeroth through second word lines WL0 through WL2, corresponding to the second process pages PG2 of the target block TBL, a word line having the highest word line number is the second word line WL2. Accordingly, pages from the fifth page PAG5 to the twelfth page PAG12, which is an MSB page MSB PAG of the third word line WL3, are set as the interference barrier pages IBPAG. The interference barrier pages IBPAG are not programmed.

After the interference barrier pages IBPAG are set in the target block TBL, the source block SBL may be erased. Also, the target block TBL may be programmed from the thirteenth page PAG13 adjacent to the interference barrier pages IBPAG.

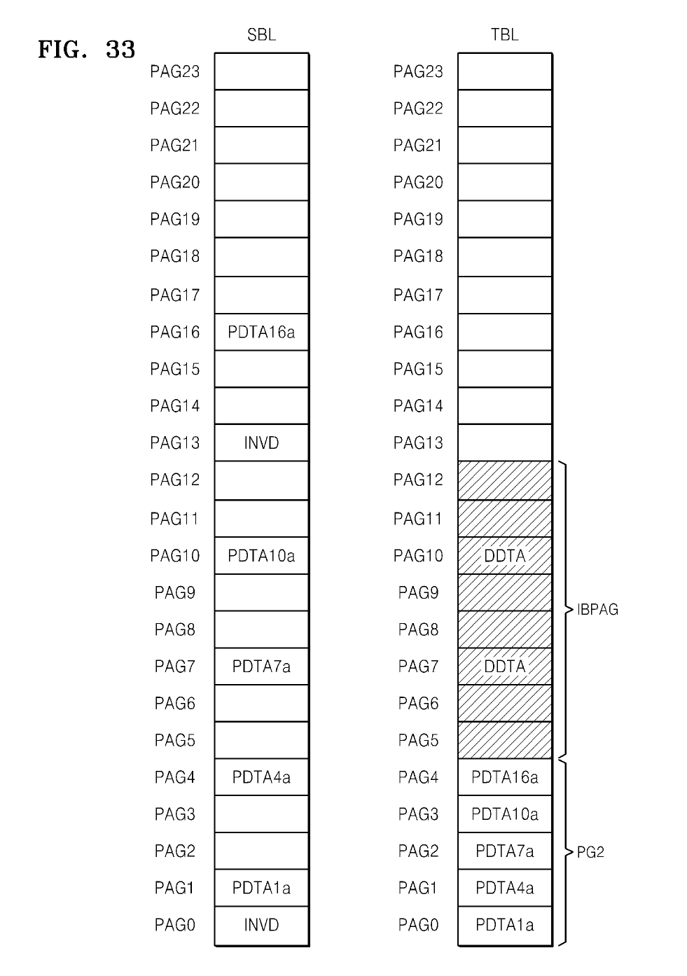

FIG. 33 is a diagram showing another example of blocks on which a garbage collection operation is performed in the flash memory apparatus MEMA illustrated in FIG. 11, according to an embodiment of the inventive concept.

Referring to FIG. 33, dummy data DDTA are programmed in the seventh and tenth pages PAG7 and PAG10 that are LSB pages LSB PAG from among the interference barrier pages IBPAG (see FIG. 32). Other than the dummy data DDTA, the structure illustrated in FIG. 33 is the same as the structure illustrated in FIG. 31. Accordingly, except for the dummy data DDTA, the descriptions provided above in relation to FIG. 31 may also be applied to FIG. 33, and thus will not be repeated.

As described above, according to embodiments of the inventive concept, a flash memory apparatus having enhanced reliability may be provided.

In a flash memory apparatus according to an embodiment of the inventive concept, only LSB pages are programmed, and CSB and MSB pages are not programmed in response to host's write requests. Accordingly, MSB page-LSB page interference phenomenon may be resolved without performing unnecessary operations, such as backup operations, and data integrity may be ensured. That is, the reliability of the flash memory apparatus MEMA may be ensured without additional operational overhead.

Also, in the flash memory apparatus, all of the LSB, CSB, and MSB pages are programmed in a target block by performing a garbage collection operation. Accordingly, although only LSB pages are programmed in response to host's write requests, pages may be efficiently used by performing the garbage collection operation. Furthermore, interference barrier pages may be set in the target block. Accordingly, damage to program data due to word line bridges may be prevented.

The above-described flash memory apparatus may be or may be included in an electronic apparatus. The electronic apparatus may be various apparatuses, such as a computing system, a memory card, a server computer, a digital camera, a camcorder, a mobile phone, and the like.

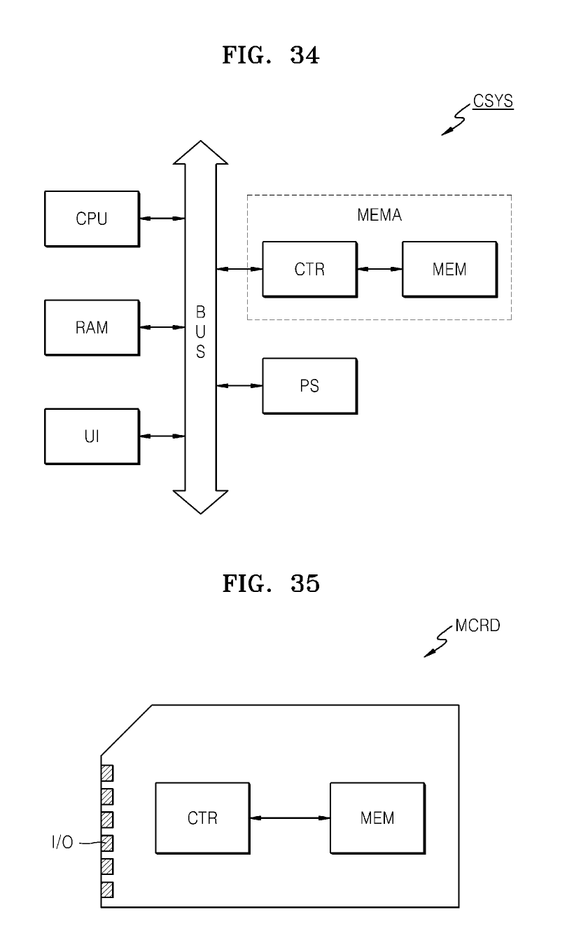

FIG. 34 is a block diagram of a computing system CSYS including a flash memory apparatus MEMA, according to an embodiment of the inventive concept.

Referring to FIG. 34, the computing system CSYS includes a processor CPU, a user interface UI, and the flash memory apparatus MEMA, which are electrically connected to a bus BUS. The flash memory apparatus MEMA includes a flash memory MEM and a control unit CTR. The flash memory MEM may store program data processed or to be processed by the processor CPU, via the control unit CTR. The flash memory apparatus MEMA may be the same as the flash memory apparatus MEMA illustrated in FIG. 1, for example. As such, according to the computing system CSYS, the reliability of the flash memory apparatus MEMA may be ensured by executing simple control without adding an additional module. The computing system CSYS may further include a power supply PS and a volatile memory apparatus (e.g., random access memory (RAM)), also connected to the bus BUS.

When the computing system CSYS is a mobile apparatus, a battery for supplying an operation voltage of the computing system CSYS and a modem, such as a baseband chipset, may be additionally provided. Also, it will be understood by one of ordinary skill in the art that the computing system CSYS may further include an application chipset, a camera image processor (CIS), mobile dynamic random access memory (DRAM), and the like, and thus, detailed descriptions thereof will not be provided here.

FIG. 35 is a block diagram of a memory card MCRD, according to an embodiment of the inventive concept.

Referring to FIG. 35, the memory card MCRD includes a control unit CTR and a flash memory MEM. The control unit CTR controls write and read operations of program data into or from the flash memory MEM in response to requests of an external host (not shown). The requests are received via an input/output means I/O. Also, the control unit CTR controls an erase operation of the flash memory MEM. The memory card MCRD may be implemented using the flash memory apparatus MEMA illustrated in FIG. 1, for example.

The memory card MCRD may be implemented as a compact flash card (CFC), a microdrive, a smart media card (SMC), a multimedia card (MMC), a security digital card (SDC), a memory stick, a USB flash memory driver, or the like. Accordingly, according to the memory card MCRD, the reliability of the flash memory apparatus MEMA may be ensured by executing simple control without adding an additional module.

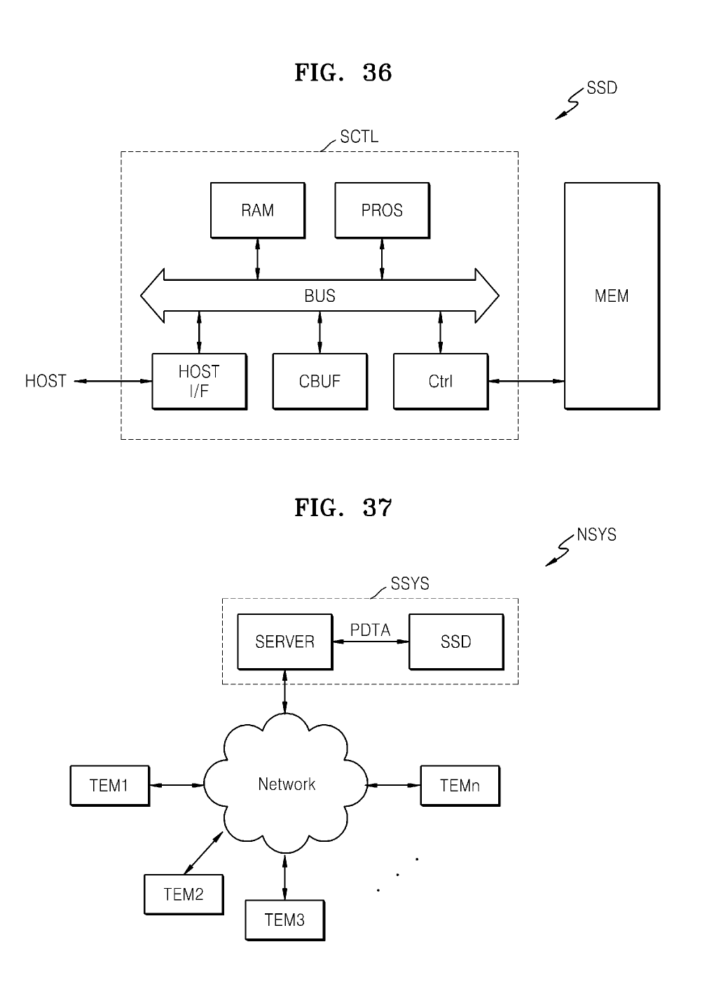

FIG. 36 is a block diagram of a solid state drive (SSD), according to an embodiment of the inventive concept.

Referring to FIG. 36, the SSD includes an SSD controller SCTL and a flash memory MEM. The SSD controller SCTL includes a processor PROS, a random access memory RAM, a cache buffer CBUF, and a memory controller Ctrl, which are connected to a bus BUS. The processor PROS controls the memory controller Ctrl to transmit and receive program data to and from the flash memory MEM in response to a request of a host (not shown). The processor PROS and the memory controller Ctrl of the SSD may be realized as one advanced RISC machine (ARM) processor, for example. Information required to operate the processor PROS may be loaded to the random access memory RAM.

A host interface HOST I/F receives and transmits the request of the host to the processor PROS, or transmits data received from the flash memory MEM to the host. The host interface HOST I/F may interface with the host by using various interface protocols, such as universal serial bus (USB), man machine communication (MMC), peripheral component interconnect-express (PCI-E), serial advanced technology attachment (SATA), parallel advanced technology attachment (PATA), small computer system interface (SCSI), enhanced small device interface (ESDI), and intelligent drive electronics (IDE). Program data to be transmitted to the flash memory MEM, or transmitted from the flash memory MEM may be temporarily stored in the cache buffer CBUF. The cache buffer CBUF may be, for example, static random-access memory (SRAM).

The SSD may be implemented using the flash memory apparatus MEMA illustrated in FIG. 1, for example. The memory controller Mctr illustrated in FIG. 1 may be implemented as the processor PROS and the memory controller Ctrl, and the volatile memory VLM illustrated in FIG. 1 may be implemented as the random access memory RAM and the cache buffer CBUF.

According to the SSD, the reliability of the flash memory apparatus MEMA may be ensured by executing simple control without adding an additional module.

FIG. 37 is a block diagram of a network system NSYS including a server system SSYS having an SSD, according to an embodiment of the inventive concept.

Referring to FIG. 37, the network system NSYS may include the server system SSYS and multiple terminals TEM1 through TEMn, which are connected in a network. The server system SSYS may include a server SERVER for processing requests received from the terminals TEM1 through TEMn and the SSD for storing program data corresponding to the requests received from the terminals TEM1 through TEMn. In this case, the SSD may be the SSD illustrated in FIG. 36, for example. That is, the SSD may include the SSD controller SCTL and the flash memory MEM illustrated in FIG. 36, and may be implemented by using the flash memory apparatus MEMA illustrated in FIG. 1, for example.

While the inventive concept has been described with reference to exemplary embodiments, it will be apparent to those skilled in the art that various changes and modifications may be made without departing from the spirit and scope of the present inventive concept. Therefore, it should be understood that the above embodiments are not limiting, but illustrative.

What is claimed is:

1. A flash memory apparatus comprising:
a flash memory comprising a plurality of blocks, each block of the plurality of blocks corresponding to a plurality of word lines, and each word line of the plurality of word lines corresponding to a first bit page and at least one second bit page; and
a control unit for controlling the flash memory, wherein the control unit is configured to map a logic address included in a host's write request received from a host to a first process page of a plurality of pages in a first process block of the plurality of blocks, and to program the first process page, and wherein the first process page is only the first bit page.

2. The flash memory apparatus of claim 1, wherein the control unit comprises:
a volatile memory for loading metadata; and
a memory controller for mapping the logic address to the first process page based on the metadata,
wherein the memory controller manages the metadata so as to prevent the first process page mapped to the logic address to become the at least one second bit page.

3. The flash memory apparatus of claim 2, wherein the host's write request further includes program data,
wherein the program data is stored in the volatile memory, and
wherein the memory controller programs the program data in the first process page.

4. The flash memory apparatus of claim 1, wherein the first bit page is a least significant bit (LSB) page, and
wherein one bit page from among the at least one second bit page is a most significant bit (MSB) page.

5. The flash memory apparatus of claim 4, wherein the control unit is further configured to copy n valid pages (where n is an integer greater than 1) in a second process block, which is one of the plurality of blocks, to ith through (i+n−1)th pages (where i is an integer equal to or greater than 0) that are n continuous second process pages in a third process block, which is one of the plurality of blocks.

6. The flash memory apparatus of claim 5, wherein the control unit is further configured to set (i+n)th through kth pages (where k is an integer greater than i+n−1) as interference barrier pages,
wherein an mth word line (where m is an integer equal to or greater than 0) from among a plurality of word lines corresponding to the n continuous second process pages has a highest word line number, and
wherein the kth page is an MSB page corresponding to an (m+1)th word line.

7. The flash memory apparatus of claim 6, wherein the control unit does not program the interference barrier pages.

8. The flash memory apparatus of claim 6, wherein the control unit is further configured to program dummy data in LSB pages from among the interference barrier pages.

9. The flash memory apparatus of claim 6, wherein the control unit is further configured to erase the second process block after the interference barrier pages are set.

10. The flash memory apparatus of claim 6, wherein the control unit is further configured to copy a plurality of valid pages of a fourth process block that is one of the plurality of blocks to the third process block, and
wherein the plurality of valid pages of the fourth process block are programmed in pages from a (k+1)th page of the third process block.

11. An electronic apparatus comprising:
a flash memory comprising a plurality of memory cells that are N-bit multi-level cells (MLCs) (where N is an integer greater than 1); and
a control unit for controlling the flash memory,
wherein the control unit is configured to program M first process pages (where M is an integer greater than 0) in the flash memory in response to M host's write requests,
wherein each of a plurality of first memory cells corresponding to the M first process pages from among the plurality of memory cells represents 1-bit information, and
wherein M×(N−1) pages that share the plurality of first memory cells with the M first process pages are not programmed.

12. The electronic apparatus of claim 11, wherein the flash memory comprises a first source block and a target block,
wherein the control unit is further configured to copy a plurality of valid pages in the first source block to a plurality of continuous second process pages in the target block, and
wherein each of a plurality of second memory cells corresponding to the plurality of second process pages from among the plurality of memory cells represents p-bit information (where p=1, 2, . . . , N).

13. The electronic apparatus of claim 12, wherein, after the plurality of second memory cells are programmed, the control unit is further configured to set a plurality of pages adjacent to the plurality of second process pages in the target block as interference barrier pages.

14. The electronic apparatus of claim 13, wherein the control unit does not program the interference barrier pages.

15. The electronic apparatus of claim 13, wherein the control unit programs dummy data in LSB pages from among the interference barrier pages.

16. The electronic apparatus of claim 14, wherein the flash memory is included in a solid state drive (SSD).

17. A method of controlling a flash memory by a control unit, the method comprising:
programming a first process page to store program data from a plurality of host's write requests in a source block, the source block including valid and invalid pages;
copying the valid pages in the source block to corresponding continuous pages in a target block, the continuous pages comprising at least one least significant bit (LSB) page and at least one most significant bit (MSB) page; and
setting at least one interference barrier page in the target block following the continuous pages.

18. The method of claim 17, wherein the interference barrier pages comprise at least one LSB page and at least one MSB page, the method further comprising:
programming dummy data in the at least one LSB page of the interference barrier pages.

19. The method of claim 17, wherein no data are programmed in the interference barrier pages.

20. The method of claim 17, further comprising:
erasing the source block after setting the at least one interference barrier page.
